(19) United States
(12) Patent Application Publication
(10) Pub. No.: US 2007/0288312 A1
(43) Pub. Date: Dec. 13, 2007

(54) Purchase-transaction-settled online consumer referral and reward service using real-time specific merchant sales information

(75) Inventor: Lee Wang, Kirkland, WA (US)

Correspondence Address: DLA PIPER US LLP, 2000 UNIVERSITY AVENUE, E. PALO ALTO, CA, 94303-2248, US

(73) Assignee: Caliber Data, Inc.

(21) Appl. No.: 11/731,119

(22) Filed: Mar. 30, 2007

Related U.S. Application Data
(60) Provisional application No. 60/788,407, filed on Mar. 31, 2006.

(51) Int. Cl. G06Q 30/00

(52) U.S. Cl. 705/14

(57) ABSTRACT

A purchase-transaction-settled online consumer referral and reward system and method using real-time specific merchant sales information is provided. The system offers merchants a one-stop place for freely publishing of their real-time and specific sales offers and offers a risk-free service to merchants to use, who will be charged only after a referred purchase occurs and a revenue income is made. The system also allows merchants to determine how much they pay to the service provider for each referred purchase transaction, based on their profit margin and market competitiveness and the system serves all merchants, online or offline, big or small, and regardless of buy, sell, and payment settlement technologies in use. The system also offers consumers a one-stop place for finding matching sales offers specifically meeting their needs, refers consumers to merchants to buy at existing merchant establishments and rewards consumers with each purchase transaction led from the service provider.

### PRIORITY CLAIM/RELATED APPLICATION

This application claims priority under 35 USC 119(e) and 120 to U.S. Provisional Application Ser. No. 60/788,407, filed on Mar. 31, 2006, entitled “A Purchase-Transaction-Settled Online Consumer Referral and Reward Service Using Real-Time Specific Merchant Sales Information”, which is incorporated herein by reference.

### APPENDICES

Appendix A (15 pages) are examples of the merchant Web site flow and merchant Web user interfaces of the purchase-transaction-settled online consumer referral and reward service and Appendix A forms parts of this specification. In particular, Appendix A contains (1) a merchant web flow specification; (2) a merchant site start page UI; (3) a new merchant setup wizard step specification; (4-5) merchant commission/reward set up UI; (6-9) merchant offer publishing UI; (10) business profile setup UI; (11) sales view UI; (12) buyers view UI; (13) account setup UI; (14) offline transaction tracking setup UI; and (15) merchant virtual terminal transaction tracking.

Appendix B (6 pages) are examples of the consumer Web site flow and consumer user interfaces of the purchase-transaction-settled online consumer referral and reward service and Appendix B forms parts of this specification. In particular, Appendix B contains (1) a consumer UI work flow diagram; (2) a consumer start web UI; (3) a web UI showing a web UI on which registered consumers find offers on a digital map; (4) a web UI displaying details of a merchant offer; (5) a web UI allowing a consumer to manually report a purchase he made to earn a reward; (6) a web UI showing consumer account set-up.

### FIELD OF THE INVENTION

The invention relates generally to a system and method for purchase transaction settled consumer referral and rewards and in particular to a computer-implemented system and method for purchase transaction settled consumer referral and rewards. The invention combines an online consumer destination strategy, a syndication strategy, a viral marketing strategy tied into a card-based loyalty component to capture consumer actions and, accordingly, a CPT (Cost Per sales Transaction) advertising model.

### BACKGROUND

In an effort to extend the market reach and effectiveness of their advertising, merchants today are looking beyond traditional media (i.e. print ads, TV, Radio) and evaluating emerging interactive communication channels such as provided by the internet, interactive cable television, (for example, Comcast local auto shopping), and a growing array of mobile devices (for example, web enabled cell phones, hand-held computers, internet connected GPS navigation in autos, etc.). Already, a number of systems and business models have been designed to exploit and capitalize on these channels, either as discreet advertising services, or as merchant directory services or a hybrid combination thereof. However, the existing systems and methods have not been designed to meet a critical set of needs shared by “offline” and “local” commerce, especially in the small and medium business (SMB) market. These critical needs recognize that many merchants are unable or unwilling to risk shifting their advertising dollars to an online model that is 1) unproven in terms of producing directly measurable sales revenue in local brick and mortar establishments and service businesses, 2) too complex to manage without dedicated and experienced marketing staff (as demonstrated by “search keyword” optimization and bidding sites), and 3) prone to deception, fraud, or manipulation (as demonstrated by so called “pay-per-click” online advertising and existing online merchant rating systems).

It is desirable to address these critical needs by 1) introducing a “transaction settled,” in particular, offline in-store sales transaction settled, online advertising system that only charges merchants for advertising that results in sales captured at (or near) the Point of Sale (POS), 2) eliminating the need for merchants to manage complexities of optimizing online advertising in order to drive online customers to their places of business, and 3) virtually eliminating deception, fraud and manipulation of click-through ads and merchant rating systems that are prevalent today by using the POS transactions as a control function. Thus, it is desirable to build a proprietary system of brokered advertising, which redirects risk of sales outcome away from merchants and shares this risk with online advertising publishers (such as Google or Yahoo). It is also desirable to build a proprietary commission bidding system in which merchants bid up consumer loyalty reward points (as captured on a magnetic card swiped with each purchase), to attract more customers, and in turn generate more revenue for the service provider.

An examination of prior art demonstrates that while many existing systems offer similar functional components such as ad price bidding (usually applied to online clicks or other online user actions), directory services (that refer customers to a business for a listing fee or even for free), and member loyalty cards for tracking and rewarding sales transactions, these systems are fundamentally different from the desired system in terms of combined functionality specifically designed and packaged to meet the needs of local merchants (as discussed above).

There are a number of existing online shopping and consumer referral services that facilitate merchant-consumer interaction, but that differ in key areas including but not limited to 1) charge model (click-ad vs. sales commission based fees, in particular on offline in-store sales), 2) coverage of offline purchases including cash transactions, 3) ease and near real-time offer publishing using digital map and web based user interface (UI), 4) advertisement relevance targeting based on geographic proximity and time.

Online Inventory Search—Local Transaction and Pick-up: One existing system provides consumers with online access to product/service availability and related information and facilitates direct processing of online orders which are then picked up at a local merchant's location. While this system can be described as an online information delivery system that facilitates offline merchandise transaction and pick up, it is severely constrained in terms of merchant participants due to the need for highly integrated and centralized inventory tracking. The expense of required data processing integration, and the fact that this system does not support online advertising in return for a commission fee makes it incompatible with the needs of SMB merchants and clearly distinguishes it from the desired system.

Online Business to Business (B2B) Affiliate Referral: Another existing system enables an individual online merchant to receive referred customers from other online sites in return for a fee. In this system, one merchant/member is joined with a multitude of associate (online) merchants (usually in complementary line of business). A system of hyperlinks is used to refer customers from affiliate sites back to a merchant that can satisfy the request, and a point system or cash based reward system is used to provide merchant incentives. This system is not designed to facilitate merchant self-publishing of advertising and special offers in near real-time so as to generate local consumer traffic at a fixed place of business or local area. Instead, it is primarily designed to build communities of networked merchants that transact most of their business online and benefit when they refer customers to affiliate sites. This system is not designed to reward customers with loyalty points or incentive rewards for their purchases.

Online Search: Search engines can refer consumers to merchants through the publishing of merchant-sponsored (fee based) advertising content or engine-indexed content (free to merchant). In general, these systems can be classified in three distinct categories: 1) Generic Search (e.g. Google, http://www.google.com, 2) Local Search (e.g., Google Local, http://local.google.com), and 3.) Shopping Search (e.g., Google Froogle, http://froogle.google.com). 1) Generic Search: These sites generally offer merchant advertisers free site indexing and generate revenue by placing paid-for advertising in front of the consumers who search. They are not local merchandising focused, thus they do not provide an efficient system that enables r merchants to publish their own offers with a means of tracking resulting sale transaction from local consumers. Generic search engines charge advertisers by “clicks” or other online actions, and they do not offer a means of capturing and tracking resulting offline transactions. The complexity and cost to merchants for optimizing a campaign based on keyword selection and bidding also deters the wide use of search engines by small and local merchants who lack required skills and resources. 2) Local Search. These sites do provide proximity-based content retrieval and advertising. However, similar to generic search engines, they do not employ a commission based system for online advertising in which revenue is driven by offline transactions (in particular offline transactions as POS) 3) Shopping Search is similar in terms of basic functionality to generic search, except that these sites offer a process for transacting an online sale. Advertising is still an upfront cost to the merchant, and the results cannot be tracked to an actual sale transaction that takes place offline (as in a local store).

Online Directory Sites are a prior art category including online yellow pages (such as Verizon's http://www.superpages.com) and local information aggregation sites (such as CitySearch http://www.citysearch.com). Some of them are online versions of paper yellow pages books and some are syndicated information sites about local communities. These sites may have two layers of merchant data (1) contact information, such as business name, address, and contact information, and (2) more specific information, such as profile, reviews, and general merchandising information, user reviews. They either generate their content free of charge to merchants, or merchants pay for a listing fee or pay for a per online action fee to get advertised. Compared to the desired system, these sites do not have a system to link advertising to an actual sales outcome (transactions). In addition, beyond submitting contact information, these sites do not have the capability for merchants to publish their own offers, making the display of near real-time advertising impossible.

Online Coupon Sites are another existing category of prior art. By definition, a coupon is a price reduction for a particular product or service. These sites (systems) may look similar to the desired system at first glance. However, they are designed in such a way as to restrict the nature of merchant offers to specific items or services for which a typically deep discount is offered as incentive for customer members (who sometimes are charged with a “club” or “member” fee to participate in the coupon savings). In contrast, the desired system does not constrain advertising offers to specific items or services, nor does it require or even encourage local merchants to deeply discount their products or services. Instead, the desired system uses a commission bidding engine to reward customers for each generic transaction with a merchant member's business and provides the consumer with a host of other important benefits such as reliable merchant rating system. Also of note is the fact that most coupon services require some type of specialized bar code scanner at the point of sale to redeem the coupon and track the transaction. Some coupon sites, (e.g., http://Valpak.com), are online versions of offline B2C direct mail services, (e.g., ValPak), that simply publish offline coupons online. These sites lack the real-time offer publishing capability. Neither do they have the commission-based charge structure. Instead, their revenue comes from listing fees. While there are certain examples of online coupon sites that are experimenting with commission based fee structure, (i.e. Google press release, Mar. 20, 2007), these have the deficiency of 1) only applying to online sales and not offline commerce, and 2) restricting offers to specific products for which the primary sale motivator is a deep discount.

Online Classified Services: These are generally focused on individual customers wanting to sell a specific item (or service) such as craigslist.com, or in the case of sites that promote merchant business, they require an upfront advertising fee (much like newspaper classified advertising). There are hybrid models of this where offline (newspaper classified ads) provide the advertiser with the additional benefit of online ad exposure. None of the services in this category provides POS tracking as part of the commission or revenue model. These services also do not provide consumer rewards (i.e. cash redeemable loyalty points). Further, they do not enable merchants to promote traffic to their store in a generic (non-item or service specific) way such as a Directory Service.

Consumer Reward/Loyalty Programs may also appear to have overlapping functionality with the desired system. These fall into 2 categories, 1) Open or Semi-Open Loop Transaction Model, and 2) Close Loop Transaction Model. These terms indicate the ability by consumers/members to redeem or otherwise utilize the points they accumulate outside of the merchant establishment with which they transacted business. Systems in this category include airline frequent flier programs, retail store and gas station frequent shopper programs. Among the many distinctions of the desired system when compared to this category of prior art is the ability for the merchant to use real-time offer publishing, proximity and time based targeting of advertising, and a commission based bidding system for generating and directing consumer traffic as is used by the system.

Online Communities: are another prior art area that share certain properties with the desired system but that are quite distinct. In this model, online communities of consumers (such as a blogging site (e.g., MySpace, http://www.myspace.com) or a user-generated content site (e.g., YouTube, http://www.youtube.com), may support the exchange of merchant performance reviews by like-minded individuals. While this is a key function that the system employs as an added benefit for its customers, (with the distinction being the added value of reliability and trust fostered by design of the desired system since it restricts input to customers that transacted bona fide purchases), these online communities are not designed to deliver proximity and time constrained advertising for local merchants, nor do they offer in-store sales commission-based charge model to advertisers.

Thus, none of the known systems and methods provide a computerized system based upon a proprietary foundation of transaction settled (POS) advertising, commission bidding and brokered online advertising services, offering 1) online consumer destination strategy, 2) a syndication strategy, 3) a viral marketing strategy tied into a card-based loyalty component to capture consumer actions and, accordingly, a CPT (cost-per-transaction, in particular for offline) advertising model.

### SUMMARY OF THE INVENTION

A purchase-transaction-settled online consumer referral and reward system and method using real-time specific merchant sales information is provided. The system and method provides a common ground online where merchants and consumers engage each other by publishing and locating specific, meaningful, and useful sales offers about products or services. The system and method permits merchants to publish and update specific sales offers online in real time and to refer consumers and track transactions in a way that works with merchant's existing business management and communication systems. The system offers a risk-free consumer referral service, where a service fee is charged after a purchase is made and allows each merchant to determine the service fee that may be based on his profit margin and market competitiveness.

The component functions of the system and method may include: (1) a Commission Tracking and Billing System: a merchant pays a portion of the sales transaction value (“commission”) to the service provider, as consideration for delivering the ad driven referral, (2) a Commission Bidding System: merchants engage in competitive bidding with each other, driving up the commission rate (from an established minimum), to pay for a greater portion of referrals in competitive market situations); (3) a real-time and on-demand Merchant Offer Publishing System: a computer based, self-serve system that works with a plurality of merchants' business communication channels including the web, the wireless, phone, and fax, that facilitates the creation and submission by merchants to either (a) advertise for a specific product or service, or (b) deliver non-item or non-service specific information intended to promote increased consumer traffic to stores (as opposed to driving a specific sale item or service as in (a)), such as having a visiting chef or musician at a restaurant, special parking space availability, accelerated service response time. Also an offer published may contain a “frame” that is a number of constraints applicable to the offer, including time, location, consumer target, etc. The Merchant Publishing System results in automated web based publishing in near real-time and may be using commercially available digital map user interface; (5) An Online Advertising Targeting System: which uses time, physical location and customer provided input (from stored customer interest profiles, user queries or presubscribed needs to service provider) to determine advertising relevance which in turn is used to target advertising only at interested consumers; (6) A computer based Offer Delivery System: a system for publishing targeted merchant offers to inquiring consumers, using a plurality of personal communication channels, including the internet, wireless, cable channels, phone, fax, and mail; (7) a Universal Transaction Tracking system that facilitates the capture and recording of cash, credit or stored value transaction card based purchase either at or near the point of sale time and location; (8) a Consumer Reward/Loyalty system: which rewards a consumer/purchaser with a portion of the commission fee charged to the selling merchant and also rewards consumers for helping refer new consumer and merchant members.

The system and method provides consumers with a one-stop online place where consumers locate sales offers that meet their needs, which refers these influenced consumers to buy from publishing merchants using any existing means of purchasing payment. The system also profit shares with consumers by rewarding those who report purchases as results of using the referral service.

For the service provider, the system and method provides a service that facilitates merchants and consumers to make purchase engagements based on useful and meaningful sales offers and accommodates existing technologies and means used in merchant selling, consumer buying, and payment settling. The system and method effectively tracks resulted purchase transactions from using the service without requiring technology integration between the service provider and merchants or requiring upgrade of merchants' existing merchandising systems.

The system and method provides an online marketplace that links consumers, who are seeking specific products or services at specific times and locations, to merchants, who offer needed products or services at specific times and locations. The system and method also universally tracks purchase transactions occurred between publishing merchants and referred consumers, regardless whether they occurred online (at web stores) or offline (at brick-and-mortar stores), or what types of payment that are used (cash, check, credit/debit card, etc.). Each participating merchant decides a service fee to pay to the service provider for each purchase transaction accomplished through the referral service, and the merchant is only charged after the transaction is accomplished. This invention also does profit sharing with referred consumers, i.e., for each transaction made by a consumer from the referral service, the consumer gets a reward in monetary value.

### BRIEF DESCRIPTION OF THE DRAWINGS

FIG. 1 illustrates an exemplary implementation of the architecture of a system for a consumer referral and reward system;

FIG. 2 illustrates an example of a purchase transaction workflow when using the system shown in FIG. 1;

FIG. 3 illustrates an example of a transaction reporting record for the system shown in FIG. 1;

FIG. 4 illustrates an example of a merchant database schema for the system shown in FIG. 1;

FIG. 5 illustrates an example of a consumer database schema for the system shown in FIG. 1;

FIG. 6 illustrates an example of a transaction database schema for the system shown in FIG. 1;

FIG. 7 illustrates a service model of the system shown in FIG. 1; and

FIG. 8 illustrates a syndication model of the system shown in FIG. 1.

### DETAILED DESCRIPTION OF ONE OR MORE EXEMPLARY EMBODIMENTS

The invention is implemented, in the exemplary embodiment, in a web-based, client/server architecture consumer referral and reward system and it is in this context that the system and method will be described. It will be appreciated, however, that the system and method has greater utility since the system and method can be implemented in other manners and with other architectures that are within the scope of the system.

In the following description, certain details are set forth in order to provide a thorough understanding of various embodiments of systems and methods. However, one of skill in the art will understand that other embodiments may be practiced without these details. In other instances, well-known structures and methods associated with computer and communication systems, the communication networks, etc., have not been shown or described in detail to avoid unnecessarily obscuring descriptions of the present invention and embodiments.

Unless the context requires otherwise, throughout the specification and claims which follow, the word “comprise” and variations thereof, such as “comprising,” and “comprises,” are to be construed in an open, inclusive sense, that is as “including, but not limited to.”

Reference throughout this specification to “one embodiment,” or “an embodiment” means that a particular feature described in connection with the embodiment is included in at least one embodiment. Thus, the appearances of the phases “in one embodiment,” or “in an embodiment” in various places throughout this specification are not necessarily referring to the same embodiment, or to all embodiments. Furthermore, the particular features may be combined in any suitable manner in one or more embodiments to obtain further embodiments.

The headings are provided for convenience only, and do not interpret the scope of this disclosure or the claimed invention.

Overview

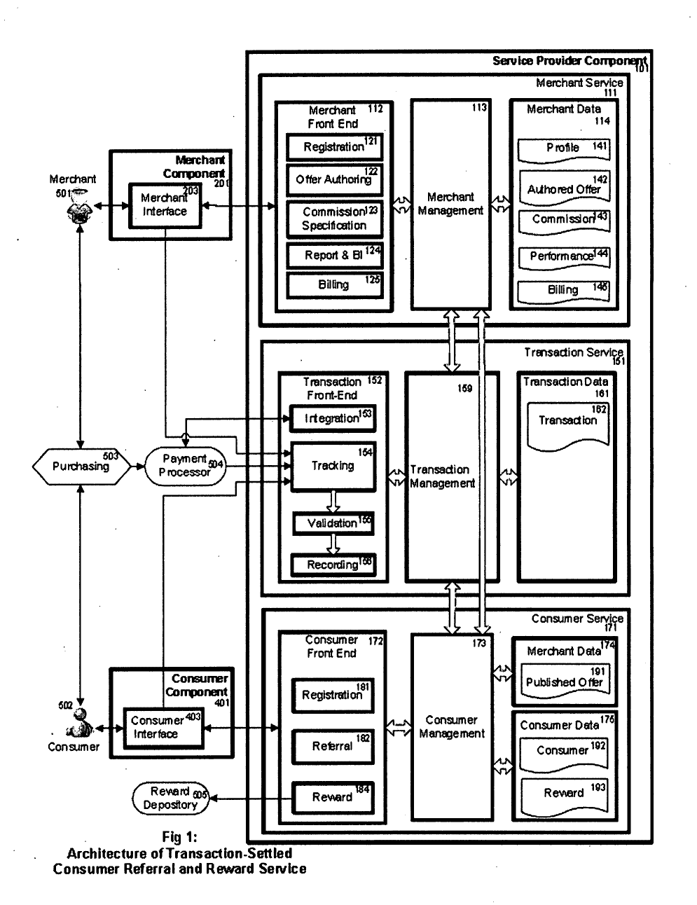

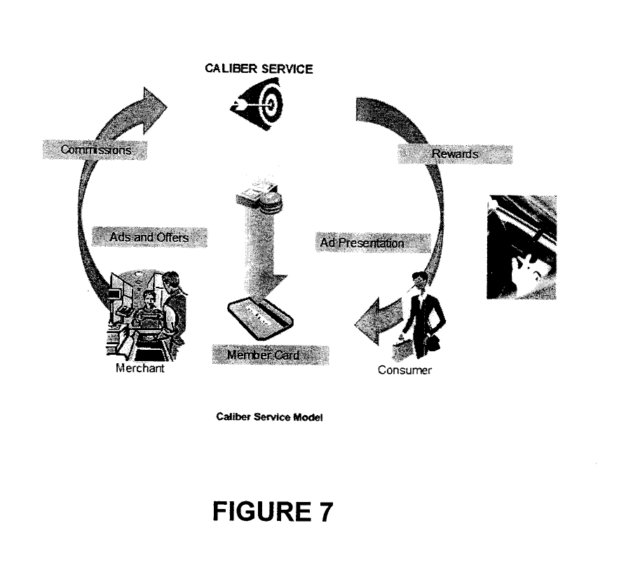

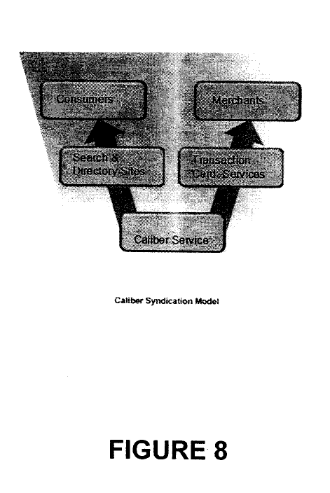

The system and its component functions may include: (1) a Commission Tracking and Billing System: a merchant pays a portion of the sales transaction value (“commission”) to the service provider, as consideration for delivering the ad driven referral, (2) a Commission Bidding System: merchants engage in competitive bidding with each other, driving up the commission rate (from an established minimum), to pay for a greater portion of referrals in competitive market situations); (3) a real-time and on-demand Merchant Offer Publishing System: a computer based, self-serve system that works with a plurality of merchants' business communication channels including the web, the wireless, phone, and fax, that facilitates the creation and submission by merchants to either (a) advertise for a specific product or service, or (b) deliver non-item or non-service specific information intended to promote increased consumer traffic to stores (as opposed to driving a specific sale item or service as in (a)), such as having a visiting chef or musician at a restaurant, special parking space availability, accelerated service response time. Also an offer published may contain a “frame” that is a number of constraints applicable to the offer, including time, location, consumer target, etc. The Merchant Publishing System results in automated web based publishing in near real-time using commercially available digital map user interface; (5) An Online Advertising Targeting System: which uses time, physical location and customer provided input (from stored customer interest profiles, user queries or presubscribed needs to service provider) to determine advertising relevance which in turn is used to target advertising only at interested consumers; (6) A computer based Offer Delivery System: a system for publishing targeted merchant offers to inquiring consumers, using a plurality of personal communication channels, including the internet, wireless, cable channels, phone, fax, and mail; (7) a Universal Transaction Tracking system that facilitates the capture and recording of cash, credit or stored value transaction card based purchase either at or near the point of sale time and location; (8) a Consumer Reward/Loyalty system: which rewards a consumer/purchaser with a portion of the commission fee charged to the selling merchant and also rewards consumers for helping refer new consumer and merchant members. These functions of the system are provided by the components and tasks that are described in more detail below with reference to FIG. 1. A service model of the system shown in FIG. 1 is shown in FIG. 7 while a syndication model of the system shown in FIG. 1 is shown in FIG. 8.

The system and method involves these parties: a service provider, a plurality of merchants who sell products/services, a plurality of consumers who buy products/services, and optionally a plurality of payment processors who settles purchase payments. The merchants affiliated with the system (the “Merchant Affiliates”) publish and update their specific sales offers in real time to the service provider. Consumers find specific sales offers that meet their needs at the time and location when and where they are needed from the service provider. The consumer who accepts the merchant offer (the “Referred Consumer”) is then referred to merchants to buy needed products or services. The service provider tracks purchase transactions between merchant affiliates and referred consumers. The service provider charges the merchant affiliate, selling a product/service based on the referral, a commission service fee for each settled purchase transaction originated from the referral service, and uses a portion of the commission service fee to reward the referred consumer who buys the product/service through the referral service.

FIG. 1 illustrates the component structure of the transaction-settled consumer referral and reward service system and method. At the highest level, the system consists of three components: a Service Provider Component 101 and two remote components—a Merchant Component 201 and a Consumer Component 401. Each of these components is described briefly below and then described in more details.

In the exemplary embodiment, the components, units and modules shown in FIG. 1 are implemented in software in which each module, component or module has a plurality of lines of computer code that, when executed by a processing unit, perform the functions and operations described below. In the exemplary embodiment, a service provider component 101 (and its unit and modules) is implemented as one or more server computers with one or more processing units, memory and connectivity wherein the computer code of the elements of the service provider component 101 are executed by the processing units of the one or more server computers. In the exemplary embodiment, a merchant component 201 is implemented as a computer system (located at the merchant site if the merchant supports this interface) that executes computer code of the merchant interface 203 to implement the merchant interface, but may also be a phone line or facsimile line that permits the merchant to interact with the service provider. Similarly, the consumer component 401 may be a computer system that displays a user interface such as by using a typical browser application that executes lines of computer code (HTML code in the exemplary embodiment) to implement a consumer interface 403.

1. Service Provider Component 101

This is the main functional component of the system. The service provider uses this component to interact with both remote components 201 and 401 and accomplishes the objects of the system.

2. Merchant Component 201

This component is a remote component that runs at the merchant side, facilitating needed communications between each of a plurality of merchants 501 and the Service Provider Component 101.

3. Consumer Component 401

This component is a remote component that runs at the consumer side, facilitating needed communications between each of a plurality of consumers 502 and the Service Provider Component 101. A consumer is an individual human being that is capable of buying and paying for goods and services offered by merchants. To the service provider, a consumer becomes a member consumer after registering with the system. Once the system authenticates a member consumer, this consumer becomes a logged in consumer. The logged-in consumer is the one who can perform all supported consumer tasks described below associated with the system.

Component Structure

I. Service Provider Component 101

The Service Provider Component contains three services: a Merchant Service 111, a Consumer Service 171 and a Transaction Service 151. Each of these services is described below in more detail.

1. Merchant Service 111

This is the module in the Service Provider Component 101 that is responsible for serving merchants (denoted by Merchant 501) through the Merchant Component 201 that is directly used by Merchant 501. The Merchant Service communicates with the remote Merchant Component 201 to accomplish the merchant-serving tasks described below.

A. Merchant Tasks

i. Merchant Registration Task

Before a merchant can publish his offers using the system, the merchant is required to register using a registration module 121 that is part of a merchant front end 112. Through the registration process, the merchant gives the service provider time-invariable information about the merchant and the business, including but not limited to business name, location, means of contact, business description, etc. Once registered, he becomes a merchant affiliate, and a merchant account and profile is created for him. After this one-time registration, the merchant uses his own credentials (such as a unique merchant ID and password) to identify himself to the service provider.

ii. Sales Offer Authoring Task

A merchant affiliate publishes or updates his sales offers (through an offer authoring module 122 in the merchant front end 112) that are specific to particular locations and times. He can do so at any time when necessary. For example, a Seattle restaurant affiliate can author an offer in the afternoon time about a dinner special for the evening of the same day. The offer may include name of the dish, a description, an image, today's special price, and hours this special is offered. The service provider runs automated approval processes and approved offers are published in real-time to consumers.

iii. Service Commission Specification Task

Before any sales offers can be published to consumers, a merchant is required to specify a service commission on a per-transaction basis through a commission specification module 123 of the merchant front end 112. The service provider charges the merchant affiliate a specified commission for each purchase transactions originated from the referred consumer to this merchant. A merchant affiliate can update (re-specify) the service commission at any time. The service provider may publish a lower bound minimum for each merchant, or by merchant industry category, merchandising category, sales location, or combined. If such a minimum is specified, all merchant-specified commissions must be equal to or higher than the published lower bound.

Commission Bidding

The service commission can be determined, in one embodiment, using a commission bidding process. The bidding process may permit a service provider (SP) to specify a plurality of minimum values for sales commission fees. By default, each qualified sales from a member merchant will be charged the pre-specified minimum. Each sales commission fee may be specified based on one or more of the following criteria: 1) types of charges that may include at least a) a commission based as a percentage of the transaction value; or b) a commission as a fixed fee per transaction, regardless of the actual transaction value; 2) merchant location that can have a location hierarchy, such as a) Country=US; b) State=Washington; and c) City=Redmond and, for each location, the SP can specify a specific minimum commission; 3) merchant business category that can have a category hierarchy, such as level 1=Automotive, level 2=Repair and level 3=Body Repair; 4) a time period so that the SP can change the minimums at any giving time, such as weekday=1% and weekend=2%, and there can be multiple time dimensions working together such as dimension 1: Day of Week and dimension 2: Day Part, etc; and 5) type of sales or buyers (targeted commission) wherein the SP supports merchants to select different targeted commissions, such as a Regular Buys commission that pay the same commission for each buy and a New Buyers commission that pay SP a higher commission for each new customer.

The system permits each service provider (SP) to allow and encourage local merchants to bid up their commissions above the specified and applied minimum values to gain preferential consumer referrals. A portion of these commissions may also be shared as a loyalty incentive by the service with the consumer by crediting their membership cards. As an example, assume that there are two Chinese restaurants A and B in the proximity to each other, offering the same type and quality of food with the same level of the service. Further assume that restaurants A and B specify to SP that they will pay 2% and 1%, respectively, for each sale that results from a referred consumer. When a consumer in the neighborhood searches for “lunch specials in a Chinese restaurant” (assuming that lunch specials from A and B are similar), due to the higher commission SP expects to receive from A, SP elects to promote A to the searching consumer more heavily (e.g. higher ranking in display order or higher number of ad display impressions) than are offered to B. One of many ways of this preferential referral is to display restaurant A's offers more prominently on a digital map based user interface. If the searching user is using textual search, SP can rank A higher than B on the returned result list. The service may allow a merchant to update its commission to the SP at any time, using any of the supported publishing methods (i.e. web interface or call center). The service may also provide commission optimization support wherein the SP may provide business intelligence data to constantly help member merchants optimize (select the best commission structure and values), reflecting current market competition and consumer behaviors, for sales maximization. The data provided to merchants shall be aggregated and only includes anonymous information that protects consumer privacy. For instance, SP may suggest a merchant raise its commission to the market average to increase sales.

iv. Performance and Business Intelligence (BI) Reporting Task

The service provider (using a report and BI module 124 in the merchant front end 112) provides merchant affiliates with two levels of reporting: the performance reporting and the BI reporting. The performance reporting is the standard level reporting service to merchant affiliates that is focused on the performance of the published sales offers (such as number of transactions from referred consumers).

The BI reporting is the premium level reporting that includes market intelligence on competitors, consumers, and sales. For example, the BI report gives each merchant affiliate an effective measure on each offer, relative to other offers from the same merchant. This report also evaluates the effectiveness of the merchant-specified commission, relative to the merchant's competitors in the same market, which helps the merchant affiliate to adjust the service commission if necessary.

v. Billing Task

This task (implemented using a billing module 125 in the merchant front end 112) enables the service provider to bill merchant affiliates on successful purchase transactions from referred consumers. Once the service provider validates a purchase transaction accomplished between a merchant affiliate and a referred consumer, this task is executed to charge this selling merchant affiliate with the pre-defined service commission.

B. Merchant Service Functional Modules

As depicted in FIG. 1, the Merchant Service 111 consists of three functional modules that work together to accomplish the above-mentioned merchant service tasks. These modules are the Merchant Front End 112, a Merchant Management module 113, and a Merchant Data module 114.

i. Merchant Front End Module 112

This is the module through which merchant interacts with the Merchant Service of the service provider to accomplish the above-mentioned merchant tasks. It contains one functional unit for each of the merchant tasks, namely,

a. Registration Unit 121

This element allows merchants to self register with the system and become merchant members (aka merchant affiliates). The registration unit may be implemented in software and may perform registration steps that include creating a merchant account with owner credentials. The unit also allows the merchant affiliate to create a plurality of business associates and assign them with credentials. During the registration, a merchant signing up also specifies the transaction tracking options, such as credit card terminal tracking, service provider's own virtual terminal tracking, manual tracking, etc. In this process, the billing procedure is set up so that the service provider can properly charge and withdraw funds for commissions earned.

The registration process also includes initialization steps in which the registering merchant creates a business profile, initially sets up commission and consumer reward plan(s). During the registration process, the new merchant may also elect to create and publish any special offers as well as creating and publishing the entire merchandizing catalog (named as regulars or regular offers in the system).

The registration element works with all supported Merchant Interfaces 203, including via internet on desktop computers and mobile devices. In addition to the exemplary software implementation described above, merchants can also use other means of business communications (such as telephone fax, or mail) for assisted registration, in which the service provider completes the actual registration on behalf of the signing merchant, either in near real time such as over the phone or offline or in near real-time such as upon receiving a paper form filled by the merchant in fax or mail. Thus, the merchant chooses the easiest way to register with the service provider, limited by the Merchant Interface 203 to which the merchant has access so that the system can be used by merchants with different interfaces including online merchants and offline merchants.

b. Offer Authoring Unit 122

This element may be implemented as a component of system software that allows merchants in a self-serve mode to create, update, and publish their offers. An offer can be a static business profile, semi-static regular merchandising information, and dynamic (changing with time or only valid in a specified time period) special offers. The offer authoring software may be implemented in a plurality of formats to accommodate supported Merchant Interface 203, including web and mobile publishing. Alternatively, it may be implemented in live assisted-mode, for example when the service provider, through a call-center, assists merchants via telephone call as they complete the publishing of an offer or the constraints associated therewith using Merchant Interface 203. Through the assisted mode of merchant self-publishing, internet access by the originating merchant is not required, making it possible for offline merchants (brick and mortar businesses without any web or internet presence), to still benefit by using they system.

c. Commission Specification Unit 123

This is an element in the system that allows merchants, at any time, to specify and update their commission offers (within a given set of constraints), for each subsequent qualified transaction made by service provider member consumers. As with other system elements described so far, the commission specification software may support a plurality of Merchant Interface 203, such as via internet or via mobile.

In addition to working in a merchant self-serve model and being implemented as a software based service, this system element may also work in a service provider-assisted mode, in which the service provider creates or updates the commission on behalf of the originating merchant. For example, as an alternative to using the service provider software, the merchant can simply use his telephone (or fax) to contact the service providers call-center and verbally update his commission offer (which is entered as change to his account in the service provider database).

d. Report & BI Unit 124

This is an element in the system that generates business reports to member merchants, performs data mining across all logged data, and makes suggestions to merchants on how to improve their sales based on an automated analysis of the stored data. This element covers both merchant sales transaction bookkeeping and optimization.

Basic reports may cover transaction and related promotional offer activities, specifying or suggesting their causal relationship (which may be based on a statistical approach and/or time based association). Basic reports cover merchant sales, commission charges, consumer rewards, offer creation/updating and relationships between the foregoing based on timing. Advanced (premium) report/intelligence may be produced as a result of further mining the logged historical data. Based upon the analysis (intelligence), the service provider has the ability of making sales optimization suggestions to merchants. For example, the provider may suggest to a merchant to increase their commission offer to drive more consumer traffic as a means of fending off an encroaching competitor. Both basic (standard) reports and BI (premium reports) may be provided with or without a fee.

e. Billing Unit 125

This is a system element responsible for calculating, charging and collecting commission fees from member merchants. It may include real-time charging (charge at transaction time) and delayed/batch charging (recurring monthly billing, for example). In a real-time charging scenario, the system collects the proper fee directly at the point of time when a qualified transaction occurs. In an offline charging scenario, the system bills the selling merchant the commission fees payable, and collects fees from the merchant on a regular basis.

To each member merchant, such capabilities of the Billing unit depend on the 3^{rd} party Payment Processor(s) this merchant uses. The Billing works with a plurality of Payment Processor 504 implementations. In real-time billing, it may work with (without limitation to) credit card processor, debit card processor, prepaid charge card processor, electronic check processor, 3^{rd} party membership processor, networked Point-of-Sale (POS) systems, etc. In offline billing, it may work (without limitation to) cash, paper check, non-networked POS systems, etc.

ii. Merchant Data Module 114

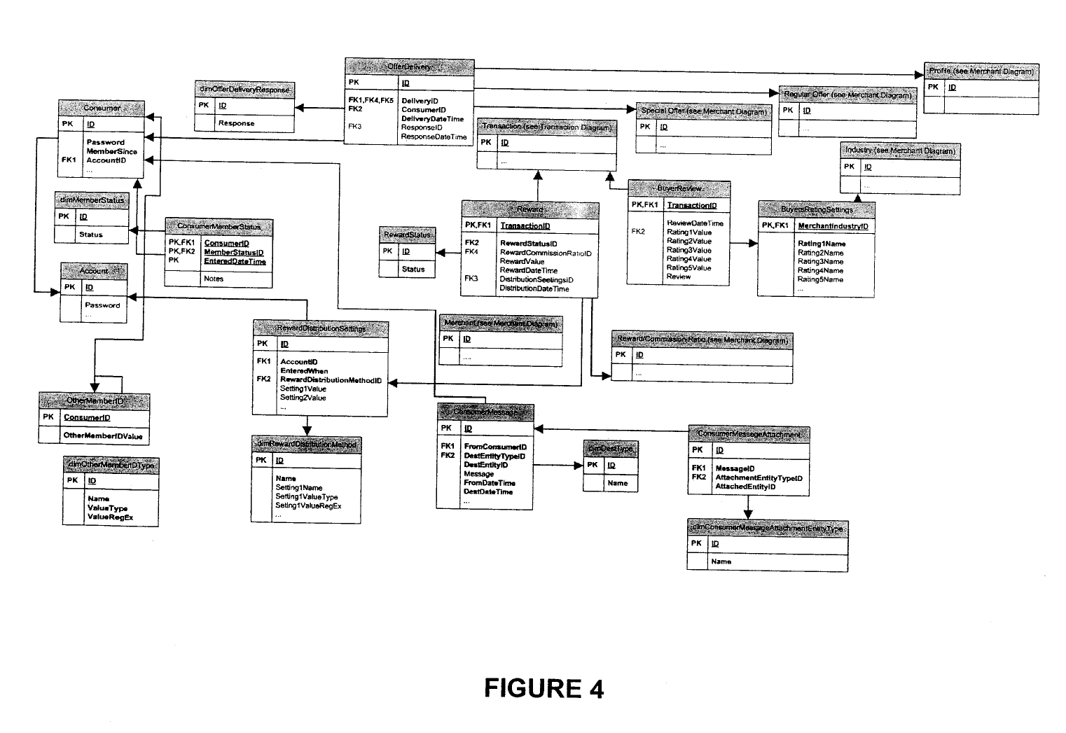

This module contains persistent databases that store data for the Merchant Service. In particular, this sub-module contains a collection of data sets for serving merchants. The stored data is managed by a Merchant Management sub-module 113 and meets the data needs for system elements in the Merchant Front Ends 112 sub-module. An example of the schema for an exemplary merchant database is shown in FIG. 4. The member databases of the merchant data module may include:

a. Profile Database 141

This database stores the time-invariant merchant data obtained through the registration process. In more detail, this is the data set that stores merchant account and profile information, including but not limited to owner account and credentials, associate accounts and credentials. Business profile data contains least frequently changing business descriptions, such as business name, location, logo, business hours, contact information, etc. This data set also stores merchant set-up configurations for transaction tracking and billing. This data set may also store a merchant rating and/or a merchant “recommendation.” These may be issued by consumers that have completed valid sales transactions with a particular merchant (to minimize erroneous or fraudulent rating entries). Merchant ratings (or “recommendations”) may be shared in a plurality of ways between consumers, either within the service provider site, or in established 3^{rd} party social networks such as http://www.myspace.com.

b. Authored Offer Database 142

This database stores all sales offers authored by merchant affiliates. Merchants also write to this database when updating their offers. This data set stores descriptions and the status of at least two types of offers: regular offers and special offers. A regular offer is a data item that describes less frequently changing product or service item(s) with less frequently changing pricing (if any). A collection of regular items may be, for example, a menu in food and drinking service industries, a catalog in retail, etc.

The Authored Offer data set may also contain special offers, which are short-term offerings from merchants with a limited valid time period. A temporary price reduction in milk for today before the store is closed is one example of special offers.

It should be noted that offers may or may not be tied to pricing or pricing changes (discounting etc.). An offer can be any message for attracting consumers to a place of business. It may contain generic, non item or discount related information (such as free hot dogs), which the merchant uses to increase customer traffic. Another example of a generic promotion is a restaurant owner who may wish to publish an offer of free parking or about a special guest chef.

c. Commission Database 143

This database stores service commissions specified by merchant affiliates. The data set contains a collection of commission specifications authored by member merchants. A commission specification sets a monetary amount, which may be a percentage of a qualified sales transaction or a fixed value per transaction, to be charged by the service provider to the selling member merchant. It also includes a set of transaction qualification criteria, such as time period, target sales, target buyers, etc. One instantiation may be a 1% commission for each sales transaction, and another may be $5.00 for each transaction—which may also be time constrained to a certain period such as applying only to transactions occurring between specified calendar dates. There may be other embodiments of commission specifications, as long as service provider receives payment as a result of bringing sales to the selling merchant.

In all cases, the service provider may require a minimum value for each type of commission specifications. For example, the provider may require that the minimum commission be no less than the greater of 1% or $0.50. The system allows merchants to bid up their commission specifications for preferential consumer referrals. In essence, the provider will promote merchant A more heavily to consumers than merchant B, when merchant A specifies a higher commission to the provider, and provided that all other conditions are the same.

d. Performance Database 144

The Merchant Service continuously tracks all aspects of performance of the published offers and stores the performance data in this database. This data set contains merchant business performance data, including but not limited to the following: transaction records (processed data from Transaction 162), buyer data, offer delivery data, causal relationship (along time and other dimensions) of sales and offering events. In addition to raw records, it may also contain derived higher-level BI data and conclusions.

e. Billing Database 145

This is the database that stores billing related data for each merchant affiliate.

iii. Merchant Management Module 113

This is the central functional module of the Merchant Service 111, where all needed logic and processes are implemented to accomplish the merchant tasks. This module takes merchant inputs from and sends merchant-bound information to the Merchant Front End module. Also, this module reads from and writes persistent merchant data to the databases in the Merchant Data module 114.

This sub-module controls work flow of tasks performed by different elements in the Merchant Front End when necessary. It also centrally manages the data operations for data safety and security for the Merchant Service 111 module. Another functionality of this sub-module is to communicate with peer management sub-modules in other modules of the Service Provider Component 101, namely, the Transaction Management Module 159 and the Consumer Management Module 173, for data transport and task synchronization when necessary.

One easy authentication example that demonstrates the flow control of this sub-module is to prohibit merchant-member-only tasks, such as Offer Authoring 122, Commission Specification 123, Report & BI 124, and Billing 125, from being executed by nonregistered users that may be attempting to use the Merchant Interface.

Service Provider administrators also use this sub-module to centrally manage the Merchant Service 111. In addition, the Service Provider's merchant support team works through this management sub-module to help merchants and to complete merchant-related tasks in provider-assisted mode.

Numerous examples of the merchant flow and the merchant user interfaces of the service described above and below are provided in Appendix A that forms parts of this description.

2. Consumer Service 171

The Consumer Service helps consumers to locate needed offers and refers consumers to purchase the service/product from a merchant affiliate who made the offer. It also rewards consumers based on purchase transactions they completed. The Consumer Service performs three consumer-related tasks, namely, Registration, Referral, and Reward. The service provider serves consumers (denoted as Consumer 502) with this module through Consumer Component 401 that runs at the consumer side.

A. Consumer Tasks

i. Consumer Registration Task

Consumers who would like to earn rewards self register using registration module 181 that is part of a consumer front end 172. By executing this task, the service provider creates a secure account for each registered consumer. A consumer uses his account credentials to identify himself with the service provider once registered. A registered consumer is entitled to receive rewards from the service provider. During the registration, a consumer may have an option to request that the service provider directly forward the reward to a 3^{rd}-party deposit account (such as a bank account) he/she designates, an authorized charity or to some other legitimate contribution which may even include purchasing equity participation in the service provider business. Typically, the consumer will elect (by system default) to spend his rewards as discounts on future purchases from in-network merchant affiliates.

ii. Consumer Referral Task

This task (implemented using a referral module 182 in the consumer front end 172) accepts and processes consumer inputs describing a need (or item search request), including the product or service category of the need, time and location constraints, etc. It then searches published offers and returns to the consumer the best matching offer(s). The service provider then provides a plurality of methods (via user interface) to direct the consumer to the merchant's physical location, or in the case of a service provider, (i.e. a plumbing service), the system may direct the merchant to the consumer.

iii. Consumer Reward Task

Once the service provider validates (substantiates) that a valid sales transaction has occurred between a merchant affiliate and a referred consumer, the Consumer Reward Task is executed to reward the buying consumer with a monetary value.

B. Consumer Functional Modules

The Consumer Service consists of four functional modules: the Consumer Front End 172, a Consumer Management module 173, a Merchant Data module 174 and a Consumer Data module 175.

i. Consumer Front End Module 172

This is the module that the Consumer Service uses to interact with consumers. It contains three functional units, each serving one of the above-mentioned Consumer Service tasks.

a. Registration Unit 181

This is the front-end component that consumers interact with to register their unique identification and account information. This function also keys the unique identification number on their member card to their account and serves to track the source of their card so that the service can track the source that referred them into the network (a key part of the incentive reward system that promotes merchant and consumer membership referrals). An example of the data flow in this process is: Account creation, Member creation, Reward Distribution Set-up, and Membership Exchange.

In this implementation, a new user first creates a consumer account. He may then add one or more individual members to the account. Members share the account but are assigned with different member IDs. Being in the same account, they may collectively pool their rewards together. At this step, consumers can set up their ID aliases, such as using their phone numbers email addresses as aliases to the official member ID. The next step is to let the service provider know the way to distribute reward for this account. There is a plurality of ways that the service provider supports reward distribution, including but not limited to using reward for next purchase. There may also be multiple sub-options, for example: a. closed-loop transaction restriction, i.e., using reward as future discounts only at the issuing merchant; b. open-loop transaction, i.e., using reward as future discounts at other in-network merchants as well), distributing reward as cash, distributing reward as direct deposits into specified financial institution, directing rewards to 3^{rd} parties such as authorized charities, designated savings accounts, lottery pools, investments (including but not limited to equity purchases in the service provider, etc.).

The last step in this implementation is membership exchange. By completing this, member consumer's membership is associated with memberships in other consumer networks (e.g., credit cards, grocery cards, etc.). When making a qualified purchase, registered credit cards or grocery cards can be recognized and used as proof of consumer membership.

b. Referral Unit 182

This is the front-end component that consumers interact with for the purpose of tracking and validating the identity of the person (consumer or merchant member) that referred them to join the system. This element utilizes merchant data, consumer requirements issued (through Consumer Interface 403 for example), consumer profile data sets as stored in the consumer data module 175, to find matching merchants and offers, and deliver the resulting information to the consumer. If consumer is interested in the offer, he may go to the merchant's physical location to transact a purchase.

Merchant data used by the referral unit 182 may include profile data, reward levels (reward being a portion of specified commission), offers (regulars and specials), as well as other merchant demographics and shopping behavioral data.

Consumer needs (requirements) data acquired by the system may include: item description (as expressed as keywords or concepts), location proximity (either manually input or detected on computing device running the Consumer Interface 403), when (a time constraint indicating when the item is required), price range (of the product or service seeking), review/ratings (of the selling merchant and/or products/services being offered), etc. Users may be permitted to customize or to set preferences for the user interface that tailor it to the way they like to enter data, (i.e. may set default field values, reorder the input form, etc.).

A consumer need may be given or captured. A need submitted to the service provider by a consumer is said to be “given”; whereas a need detected by the service provider is said to be “captured.”

A number of data mining (DM) and information retrieval (IR) algorithms may be applied to rank offers and offering merchants by the given need. In the system, one factor considered by such an algorithm is the merchants' commission specifications. The service provider more heavily promotes consumer traffic (or features with greater frequency or more prominence the merchants' display ad), as compared to merchant offers for a similar item or service that offer a lower commission level.

The referral unit 182 may support both “soft referrals” and “hard referrals.” A soft referral is considered successful and valid when a sales transaction is completed between a member merchant and a member consumer, regardless of whether this transaction is directly the result of a specifically advertised item or service. A hard referral, in contrast, requires a proof of a specific offering from the merchant before a transaction can be made. Merchants may determine which means of referrals to use; and this information may be published to the consumers.

c. Reward Unit 184

This is the front-end component interacting with consumers for the reward task. This component is also capable of wiring (electronically transferring or delivering) consumer rewards with a consumer-specified Reward Depositary 505 (such as bank accounts). In particular, this system element executes the consumer rewarding program, based on each consumer's qualified purchases. In one implementation, the provider specifies a fixed ratio between reward and commission. That is, the provider always returns a fixed portion of the received commission fee from the member selling merchant to the buying member consumer. For illustration's sake, we assumed this ratio is ⅓ in this application. In this implementation, the reward steps go as follows:

1. A member consumer makes a qualified purchase from a member merchant

2. The service provider charges the selling merchant a commission fee at the pre-specified level or ratio.

3. The selling merchant pays the commission fee

4. The service provider forward ⅓ of the received fee to the buying consumer as the reward for this purchase he made in step 1.

The Reward 184 element also distributes rewards earned by consumers to specified Reward Depository 505, as specified in the consumer Registration 181 element.

ii. Merchant Data Module 174

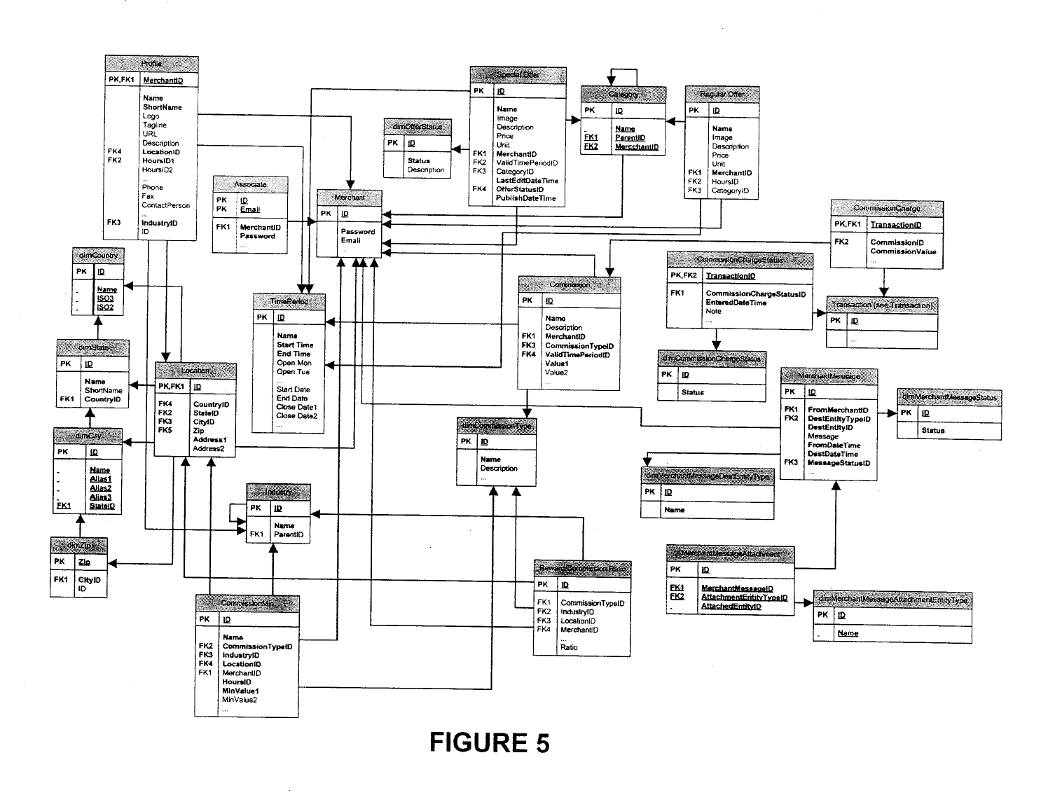

The Merchant Data Module in Consumer Service stores the data from merchant published offers 191 that are used to respond to consumer requests resulting in referrals to qualifying merchants. This module may contain a cache of merchant data that is used by consumer-related tasks. An example of the database schema for a consumer database is shown in FIG. 5. This module contains the Published Offer database 191 which is a copy, either physical or logical, of the Authored Offer Database 142 in Merchant Data module 114 of the Merchant Service 111. It contains offers that are proved by the service provider, which are available to consumers.

iii. Consumer Data Module 175

This is another data sub-module under Consumer Service 171, containing consumer profile and behavioral data. It may also store persistent consumer data, including two logical data bases: a Consumer database 192 and a Reward database 193.

a. Consumer Database 192

This database contains information for registered consumers, including a profile, account credentials, reward depository designation, etc. It may also contain behavioral data over time, as well as derived business intelligence data and findings.

b. Reward Database 193

This database contains reward history for registered consumers who received rewards from the service provider. The data set contains reward records, in lieu of transaction data stored in Transaction 162 data set. This data set provides the basis for consumer rewarding.

iv. Consumer Management Module 173

This module is the central management module for the Consumer Service 171, where all consumer-related logic and algorithms are implemented. It communicates with the Consumer Front End module to get from and send data to consumers. It also centrally manages the data operations for data safety and security for its parent the Consumer Service 151 module and thus writes to and reads from the Merchant Data module 174 and the Consumer Data 175 module. The Consumer Management Module also communicates with other member services of the system in the Service Provider Component 101 namely, the Merchant Management Module 113 and the Transaction Management Module 173, for data transport and task synchronization when necessary. For example, this module connects with the Merchant Management module 113 in Merchant Service 111 for synchronizing the Published Offer database 191 with the Authored Offer database 142, as well as passing information from the Consumer Data module 175 to Merchant Service for merchant reporting and billing purposes. The Consumer Management module also has a direct connection to the Transaction Management module 159 of the Transaction Service 151 for transaction/consumer-related data exchanges.

Service Provider administrators also use this sub-module to centrally manage the Consumer Service 171. In addition, the Service Provider's consumer support team works through this management sub-module to help consumers and to complete consumer-related tasks in provider-assisted mode.

Numerous examples of the consumer flow and the consumer user interfaces of the service described above and below are provided in Appendix B that forms parts of this description.

3. Transaction Service 151

In the preferred embodiment of this invention, the service provider does not control or own the actual purchase transactions; and this system module under the Service Provider Component 101 deals with purchase transactions between merchants and consumers. A selling merchant and a buying consumer can complete a purchase transaction anywhere (online or offline) by any means of payment (cash, check, credit card, debit card, etc.). However, the system tracks, validates, and records those qualifying transactions that occurred between merchant affiliates and registered consumers in order for the service provider to correctly charge the selling merchant with a commission fee and pass on a portion of the fee to the buying consumer as a reward incentive. The Transaction Service consists of the following tasks to track, validate and record qualifying transactions:

A. Transaction Tasks

i. Transaction Integration Task

This task (implemented using an integration module 153 that is part of a transaction front end module 152) integrates transaction tracking with electronic means of payment settlement through a plurality of Payment Processors 504. A payment processor can be owned by the merchant, or by a 3^{rd}-party payment clearing house, or is an online or mobile payment service provider. With the consent of a merchant affiliate, the service provider executes the Transaction Integration Task to integrate the Transaction Service with any/all of the electronic payment processors the merchant uses. Once integrated, the service provider instantly tracks occurred transactions settled by any of the integrated settlers.

Note the system also tracks transactions through payment systems not integrated with the service provider. An integrated tracking captures a transaction in real time at the point when the transaction occurred, whereas in a non-integrated tracking scenario, the buying consumer may report the occurred transaction after it has occurred.

ii. Transaction Tracking Task

This task (implemented using a tracking module 154 of the transaction front end module 152) tracks purchase transactions that occurred between a merchant affiliate and a referred consumer. When a payment processor is integrated with the Transaction Service, the processor transmits information of a qualifying transaction to the Transaction Service in an automated fashion. For example, suppose this task is integrated with a credit card payment clearing house. In this case, the service provider tracks all transactions instantly when they are settled by this clearing house.

This task also tracks those purchase transactions, whose means of payment are either not electronic or not integrated with the service provider. The system facilitates consumer-initiated tracking methods, in which the buying consumer (or the selling merchant on behalf of the consumer) reports the occurred transaction to the service provider after it the payment is settled.

By supporting both integrated and manual transaction tracking, the system can provide its services to all merchants and consumers, regardless of the specific means of payment settlement.

iii. Transaction Validation Task

Once a purchase transaction is reported by the Transaction Tracking Task, it is forwarded to the Transaction Validation Task (implemented using a validation module 155 in the transaction front end 152) to validate the transaction. This task is necessary to minimize fraudulent transaction reporting. In this task, the service provider of the system tests the truthfulness of a tracked transaction based on the transaction information reported.

iv. Transaction Recording Task

This task (implemented using a recording module 156 in the transaction front end 152) receives information of validated transactions from the Transaction Validation Task, and records the information about this transaction into the persistent Transaction database. After a transaction is recorded by the service provider, the service provider bills the selling merchant for a service fee and rewards the buying consumer with a monetary value.

B. Transaction Functional Modules

The Transaction Service Component consists of these modules for executing above-mentioned transaction tasks: the Transaction Front-End module 152, a Transaction Management module 159, and a Transaction Data module 161.

i. Transaction Front-End Module 152

This module interacts with merchant, consumer, and payment processor for transaction tracking. This is a system sub-module containing a set of system elements that communicates with the Merchant Component 201, Consumer Component 401, and Payment Processor 504 for tracking, validating and recording sales transactions. It contains functional units, one for each corresponding transaction task:

a. Integration Unit 153

This unit integrates with the Payment Processor 504 for automated transaction reporting and contains a plurality of software modules, each works with a different Payment Processor 504, for tracking qualified transactions made thru the Payment Processor 504. For example, the Integration element may work with and track transactions occurred on 3^{rd}-party credit card terminals, provider's own tracking terminal, and manual cash transactions. Pieces of the software may be embedded in payment processor hardware. This element works to ensure that the Payment Processor in use works correctly with the Tracking 154 element.

b. Tracking Unit 154

This unit works with Payment Processor 504 for automated transaction tracking, or works with consumers via the Consumer Interface 403 and with merchants via the Merchant Interface 203 for manual transaction/sales tracking. It has three categories of implementation: direct tracking from merchant via Merchant Interface 203, indirect tracking from 3^{rd}-party Payment Processor 504, and direct tracking from Consumer Interface 403.

A merchant may use provider furnished Merchant Interface 203 to track sales transactions. In this scenario, The Tracking element 154 directly receives authenticated transaction data from Merchant Interface 203.

The Tracking element 154 may also work with a plurality of 3^{rd}-party Payment processors. In this scenario, it receives transaction data from supported Payment Processor(s) 504, after the Payment Processor is integrated with the Integration 153 element. The Tracking element pumps data through the Validation element 155. Through the Integration 153, Tracking works with a plurality of Payment Processors 504.

The Tracking element 154 may also work with Consumer Interface 403 for transaction tracking. An example will be covered later in this section.

The Tracking software supports two types of transaction tracking, real-time or offline. In real-time tracking, the software running on Payment Processor 504 passes necessary data to the Tracking element 154 at the time a transaction occurs. All subsequent options (Validation 155, Recording 156) also occurred in real time. The end effect is that this transaction is tracked, validated and recorded as it happens. Real-time transaction tracking requires software integration.

Another type of Tracking 154 is offline tracking, which may or may not require software or integration. For example, in case of a cash transaction between hands of a selling merchant and a buying consumer, the service provider may implement a set of user interface in Consumer Interface 403 to work on internet or mobile devices, so that the buyer can report the occurred transaction after it has happened to the provider via a Web page, an email, or a short message on mobile devices.

c. Validation Unit 155

This unit tests the truthfulness of tracked transactions based on the reported transaction data forwarded from the Tracking unit by performing necessary validations against it to minimize possible frauds. It performs cross checks on data received against known and trusted saved data.

As one possible embodiment, the following illustrates the validation algorithm for manual transactions.

1. Provider issues to merchants a set of stickers, each printed with a unique ticket number and comes with a valid time period.

2. When the merchant made a sell to a member consumer, he gives such a sticker to the buyer.

3. The buyer consumer later logs onto the system on Consumer Interface 403 and reports this purchase by filling up a form online with the obtained ticket number, together possibly with the name of the selling merchant and approximate purchase date and time.

4. The Consumer Interface 403 passes the reported transaction data (from buyer) to the Tracking element 154

5. The Tracking element 154 passes the data to Validation 155.

6. The Validation element 155 cross checks the received data (ticket number, selected merchant and approximate purchase time) against the Transaction data set that contains the original record of the ticket number, the issuing merchant, and the valid time period of this ticket number.

7. The Validation element 155 will invalidate this reported transaction when any of the cross checks fail.

Note in this embodiment, the merchant can only specify commissions by a fixed monetary value, since the transaction value is not reported nor validated.

When the transaction data is originated from a 3^{rd}-party Payment Processor 504, the payment processing software passes along necessary identification/credential data (for example, processor device ID, associate/owner account used when processing the transaction, consumer membership, etc.) for Validation 155. Merchant may specify commission by percentage of sales value in scenarios where sales value may be tracked and authenticated.

d. Recording Unit 156

This unit records validated transactions in the Reward database 193 to enabling merchant billing and consumer rewarding. In particular, this element writes the transaction record into the Transaction data set 162, along with other necessary environmental values such as record time, reported by, validation results, etc.

ii. Transaction Data Module 161

This is the data sub-module under Transaction Service 151 module, storing transaction-related data in the following database:

a. Transaction Database 162

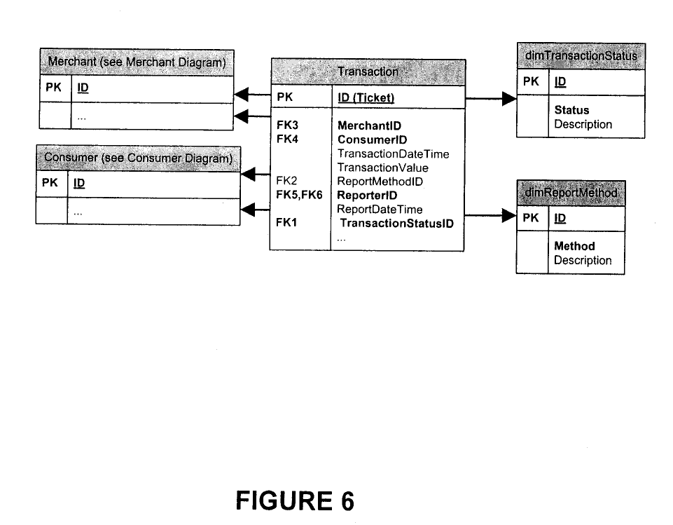

The stored transaction records are used by both the Merchant Service 111 and the Consumer Service 171. An example of the transaction database schema is shown in FIG. 6. The Merchant Service uses the transaction records for merchant reporting and billing, whereas the Consumer Service uses these records to reward referred consumers. In particular, this data set contains transaction records received from Tracking 154 and processed by Validation 155 and Recording 156.

iii. Transaction Management Module 159

This module is the central management module where all transaction-processing logic and processes are implemented. The Management module manages and communicates with the Front-End modules to receive, validate and record transaction information. It also centrally manages the data operations for data safety and security for the Transaction Service 151 module and thus reads from and writes to the Transaction Data Module to access transaction records. Another functionality of this sub-module is to communicate with fellow management sub-modules in other modules of the Service Provider Component 101, namely, the Merchant Management Module 113 and the Consumer Management Module 173, for data transport and task synchronization when necessary.

Service Provider administrators also use this sub-module to centrally manage the Transaction Service 111.

II. Merchant Component 201

The merchant component is a remote component running at the merchant side that functions as an interaction bridge between the merchant 501 and the service provider. It consists of a Merchant Interface module 203. A merchant herein is defined as is either the owner of a business or a business associate of the owner. A business owner, after logging in, can perform all the tasks as supported in the Merchant Service 111. Business associates can only perform transaction tracking, after authenticate themselves with the Merchant Service 111. To the service provider, a merchant becomes a member merchant after registered. Once the system authenticates a member merchant, this merchant is said to have logged in. A logged-in merchant is the one who can perform all supported merchant tasks.

I. Merchant Interface Module 203

This module directly interacts with the merchant and merchant's business system. It also communicates with the Merchant Front End 112 to accomplish merchant tasks.

A merchant may use one or multiple implementations of the module that are suited with him and/or his business management system. A module implementation can be either tangible (such as a Web UI) that is installed at the merchant end computer or intangible (such as a phone number to the service provider) that the merchant remembers. Another implementation of this merchant interface may be a merchant-side program that works with merchant's computerized business management system and communicates with the service provider.

This component also provides programmable and manual implementations to work with the Tracking unit 154 enabling merchants to manually report transactions.

This element contains a plurality of user interface for merchants to interact with Merchant Service 111. This is the user interface that works with the Merchant Front End 112 to perform merchant registration, offer authoring, commission specification, report sales, reporting and billing.

This element is used by Merchant 501 and communicates with Merchant Service 111 on existing business communication channels used by Merchant 501. This element can be implemented as software or provided as hardware.

For merchants using internet for business communications, this element may be implemented as a set of Web Pages or a web site. For merchants do not have internet access for business (or personal use as well), phone and fax may be used in this element as the merchant interface.

III. Consumer Component 401

The consumer component is a remote component running at the consumer side, facilitating communications between consumer 502 and the service provider. It consists of a Consumer Interface module.

1. Consumer Interface Module 403

This module directly interacts with the consumer and communicates with the Consumer Front End 172 at the service provider site for accomplishing consumer tasks of the system. This module has multiple implementations, tailored to different communication technologies consumers use, ranging from those tangible, either a piece of software installed at consumers' computers/devices (such as Web UI, Mobile UI) or a piece of hardware issued to consumers with necessary software embedded (such as a dedicated device), or intangible (such as a phone number to call the service provider). A consumer chooses one or more implementations of this module that work best for him. Consumers also use this interface to interact with the Transaction Tracking unit 154 to report transactions by themselves.

In more detail, this element contains a plurality of user interface for individual consumers to interact with the Consumer Service 171. This is the user interface that works with the Consumer Front End 172 to perform tasks such as consumer registration, referral (finding needed products/services), report purchases, and getting reward for qualified purchases. The multiple user interfaces of this element may be used with a plurality of personal communication channels, in which consumers can be connected with the service provider. These channels include, but are not limited to, the internet, the wireless network, and the telephony network.

Mobile Advertisements, Cable TV Advertisements and Map Display

The service and system may generate mobile advertising, cable television advertising or map displays with advertisements that are displayed to consumers of the system and present the offers to the consumers. The mobile advertising may occur over the web to a mobile device (a commercial example of this at located at http://air2web.com). A commercial example of cable television advertising is the Comcast Classifieds ON DEMAND in which cable viewers use their remotes to view local auto listings on Comcast's ON DEMAND Service. The service described above may use both mobile and cable television advertising that may be provided by third parties as advertisement delivery channels for getting merchant's offers to consumers.

The service may also use digital map displays with advertisements to present the offers to the consumers. A number of commercial digital map service providers (notably Microsoft Virtual Earth http://local.live.com and Google Earth http://local.google.com) allow merchants to post their information on the map. In these typical systems, the merchant information shown on map stay at the contact information level, but some map providers allows linkage from the map to a merchant's web site. The service described above can use these existing map display systems with the advertisements of the service. In one embodiment of the system, the service provider may host the map application and using the map API to overlay the offer data on the map (self-hosted model). In another embodiment, the provider can deliver offers to a 3^{rd}-party-owned digital map (such as Google's own map site) and have the 3^{rd}-party to present offers to consumers (syndication model). In the service, map advertisements may by shown for local shopping specific search (the service supports more and specific parameters, such as time period and price range) and supports rendering real-time and specific offers on the map (see UI screenshots in Appendix B).

Purchasing 503

As shown in FIG. 1, the system/service permits a purchasing transaction 503 to occur between the merchant 501 and the consumer 502. Purchasing is an action occurred between a merchant and a consumer, involving (1) transferring ownership or creating a lease of a product from or performing a service by the selling merchant to the buying consumer and (2) buying consumer pays a monetary value in exchange of ownership or lease of the product or rendered service by the merchant. The entire process is called a transaction, and the monetary value changing hands is called the transaction value, sales value (from selling merchant's perspective), or purchase price (from buying consumer's perspective). A purchasing action may be settled and recorded by a Payment Processor 504.

Payment Processor 504

A payment processor, for the purpose of this application, is a tracking device or method that tracks the occurrence of a qualified transaction (that is, a transaction occurred between a member merchant and a member consumer). It may be implemented by the service provider or by a 3^{rd}-party as a piece of software, a piece of hardware, or a combination of both.

This application may support a plurality of Payment Processors, including those running in credit card terminals, those running on the internet, etc.

Work Flow

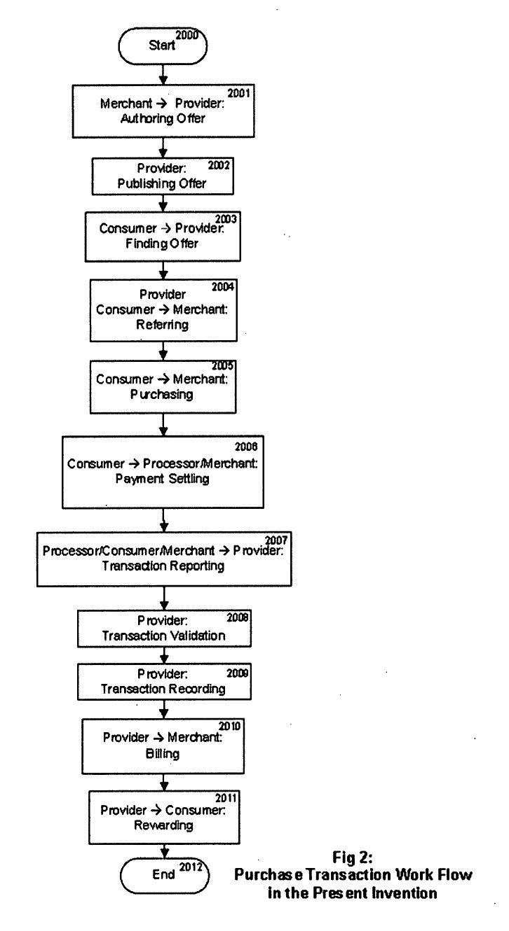

FIG. 2 illustrates the work flow of the transaction-settled referral and reward service in the preferred embodiment. The work flow specifies interactions among a merchant affiliate, a registered consumer, the service provider, and optionally a payment processor.

The work flow begins at step 2000. First, a merchant affiliate specifies an offer to the service provider, by either authoring a new sales offer or updating an existing offer 2001. Then the service provider publishes this offer to consumers 2002 once proved. A consumer goes online and uses the referral service to find an offer that matches his needs 2003. He then becomes a referred consumer and the service provider refers him to the selling merchant 2004.

The purchase happens in the merchant's establishment between this registered consumer and the selling merchant who published offers 2005. The actual purchase can occur either online in a Web store or offline in a brick-and-mortar store, and can use any means of payment. In the preferred embodiment, the system does not own the purchase payment settlement. The payment and settlement can be done through the selling merchant or a 3^{rd}-party payment processor 2006. After the payment is settled, the consumer, the merchant (asked by and on behalf of the consumer) or the payment processor reports this transaction to the service provider 2007.

When the provider receives the information about this transaction, it validates it 2008 to ensure that what it received is not a fraudulent transaction. Suppose this transaction reported is a valid one, the service provider records it 2009.

Once this transaction gets recorded, the service provider charges the merchant a service fee for the service rendered leading to this transaction 2010. The service provider also rewards the buying consumer with a portion of the fee it receives from the selling merchant 2011.

### MERCHANT SERVICE PREFERRED EMBODIMENT

I. Merchant Interface Means

The system provides a plurality of merchant interface to enable merchants to interact with the service provider for executing merchant-related tasks and to report occurred transactions, The merchant selects and uses the interface suited with his business communication means (Web, phone, etc.) and his business management means (computerized, manual, combined). In the preferred embodiment of the system, the following merchant interface means are offered: a Web-based user Interface (Web UI) and a telephone-based user interface (Phone).

A merchant, with an internet access, can use the Web UI to interact with the service provider. A merchant, without an internet access, can pick up a phone and call the service provider to accomplish the same merchant-related tasks in the system.

The service provider also provides means of programming interface for merchants' computerized management systems to communicate with the service provider's computer system without any human intervention. This is the integrated option.

II. Merchant Affiliation

To use the services provided by the service provider, a merchant needs to register with the service provider. Once registered, this merchant becomes a merchant affiliate to the service provider, and can publish his sales offers to consumers. After the registration, a merchant affiliate uses his account credentials to identify himself with the service provider.

III. Merchant Offer Authoring

The service provider of the system provides multiple means (as part of the Merchant Interface) for merchant affiliates to author and update sales offers. In the preferred embodiment, the system supports both manual and automated means of offer authoring and updating.

1. Manual

If a merchant has Internet access, he can use the merchant Web interface to author and update his offers. The service provider also provides a telephone service so that merchants do not have Internet access or do not use Web can make phone calls to author or make updates of his offers. A phone-in merchant may input data using keypad or utilizing voice recognition technology, or he may talk to a support person if needed. Manual authoring work best for merchants who have a limited number of offers and/or only need to update offers no more than several times a day. It also Works for merchants who do not have computerized management systems.

2. Automated

For merchants who use computerized business management systems, have large numbers of products or services to offer, and need to frequently updates, their systems can be programmed to use a set of provided Application Programming Interface (API) to communicate with the Merchant Front End at the service provider side for automated offer authoring and updating without merchants' human intervention.

IV. Merchant Offer Specification

In the preferred embodiment of the system, a merchant offer that is publishable contains at least descriptions in textual and/or multimedia format of these aspects: body and frame (aka constraints).

An offer body describes the nature of the offer, including but not limited to the offer's purpose, functionality, design, features, and benefits. The body of an offer is less likely to vary, compared to the frame of an offer. The frame of an offer describes the sales scope of the body, including but not limited to the specifications of quantity, price, time period and geographical location that the price is to be honored. A frame of an offer normally varies more frequently than the offer body itself. Note that an offer can have one body and multiple frames, each of latter with different specifications. Updating an offer may mean updating the body, the frame or both.

V. Offer Publishing

Once an offer is authored or updated, the service provider immediately runs an automated process to prove it or reject it by the required offer specifications and certain business rules. Once approved, the offer is published to consumers in real time. A merchant may also have delayed publishing, in which for an offer of his he can select a point in time at which this offer wile published to consumers.

VI. Merchant Service Fee (Commission)

The service provider charges a merchant affiliate a service fee (“commission”) after he makes a purchase transaction with a referred consumer. The service fee is pre-specified by the merchant. Generally, each merchant should determine his service fee to the service provider based on the following factors: (1) the service fee cannot be lower than a minimum value published by the service provider and (2) the service fee should be competitive in the market where the merchant is located, online or offline.

The service provider may define a minimum service fee for each merchant, for each category of merchants, for each geographical market, and/or for certain periods in time. No offers shall be published when the specified service fee is not specified or is specified by lower than provider's minimum value from a merchant.

The service provider let merchants know that when there are two offers both meeting a consumer's needs, an offer O1 from a merchant A with a higher service fee will be referred to this consumer more promptly over an offer O2 from another merchant B with a lower service fee. Therefore, a merchant pays a higher service fee has an advantage of getting more referrals from the service provider.

Also, the system provides merchant affiliates with a plurality of service fee models to use, each with its own consequences in terms of implementation and transaction tracking complexity. In the preferred embodiment, the service provider may offer these fee models to merchant affiliates:

1. Member-qualified and fixed-valued

2. Member-qualified and fixed-percentage

3. Offer-qualified and fixed-valued, and

4. Offer-qualified and fixed-percentage.

Different transaction qualification criteria exist for member-qualified and offer-qualified models. Under a member-qualified model, the service provider charges the selling merchant affiliate a commission fee for each transaction, regardless what is sold, as long as the buyer is a consumer member of the service provider's. In order to charge the merchant under an offer-qualified model, in addition to the reward membership proof, the transaction record must also show that the consumer bought a product or service that is advertised by a published offer while the offer is valid.

A member-qualified model simplifies the purchase transaction and purchase tracking, since the only proof for qualifying such a purchase is reward membership. On the other hand, an offer-qualified model is more targeted since it attracts consumers to buy only the advertised offers. But to qualify for such a transaction, the proof of the offer is also needed at purchase.

A fixed-percentage model and a fixed-valued model differ in how the commission fee is calculated. Under a fixed-value model, a selling merchant specifies a service fee in monetary value (such as $0.50). This given monetary value is charged by the service provider per purchase, regardless of the actual selling price of the purchase. On the other hand, under a fixed-percentage module, a selling merchant specifies a percentage number (such as 5%) as the service fee rate. The service provider charges this percentage of the actual selling price when a qualifying transaction is made.

Comparing to a fixed-percentage model, a fixed-value model is easier to implement in transaction tracking since the transaction reporting does not need the actual sales price, nor does the service provider need to validate the purchase price.

In the system, each merchant may choose the charge model to use, and this knowledge is published to consumers as part of merchant offering. The set of available fee models to each individual merchant may be limited due to the transaction tracking options this merchant has. For example, to minimize transaction reporting fraud, the service provider may only allow a merchant to use a fixed-percentage fee model when this merchant can only work with manual tracking in which his customers manually report occurred transactions to the service provider.

Merchants may also select and/or customize their reward plan(s), tailored for different business needs. A mature business may want to have repeat buys from its exiting customer base. In this case, the merchant may choose a universal reward plan, where the same reward is given to all purchases, regardless whether these purchases are from new customers or from existing customers. In contrast, a new business may need new customers. In this case, the merchant may choose a New Buyers' plan, where he can lift up the reward level for purchases from new customers.

In the preferred embodiment, the service provider may also incrementally rewards merchant affiliates with high sales volumes. The reward may be given as a discount on the service fee. The system provider defines multiple levels of fee discounts. Higher a level a merchant is at, higher the discount will be applied to this merchant's service fee. When a merchant affiliate reaches a certain discount level measured by the volume of sales originated from the service provider over a period of time, his service fee is reduced by the discount set forth at this level.

### CONSUMER SERVICE PREFERRED EMBODIMENT

I. Consumer Interface

The system provides a plurality of consumer interface to enable consumers to register themselves, to report transactions, to find offers, and to receive rewards after purchases. A consumer may select the best means of consumer interface working for him/her and may switch at any time. In the preferred embodiment, the set of provided consumer interfaces include but not limited to a Web-based user interface (Web UI), a user interface running on mobile devices (Mobile UI), phone calls (Phone), and postal mail services (Mail).

When a consumer has a laptop or desktop computer with an internet access, the Web UI may be the most convenient way to interact with the service provider, on which all consumer-related tasks can be executed. When a consumer is on the go, the Mobile UI may be his best choice. Alternatively, a consumer can also make phone calls to the service provider for executing consumer-related tasks. The Mail interface is mainly used as one means for consumers to report transactions to the service provider.

II. Reward Program Membership

A registered consumer entitles rewards in monetary value from the service provider for making purchase transactions, as a result of using the referral service. A secure account is created for each registered consumer with proper credentials (such as a consumer ID and password). The credentials establish the identification of a registered consumer.

Each registered consumer is a member of the reward program sponsored by the service provider. A reward profile is created that the consumer can access with his registration credentials. The service provider also issues a reward member card the consumer can use to identify him/herself as a reward member when necessary.

III. Finding Offers

A consumer may start to use the referral service by querying the service for finding published offers that meet his/her needs. He can use any means of the interactive consumer interface to query (excluding Mail). For example, he can use the consumer Web UI to query, use the mobile UI when on the road, or he can make a phone call to query instead.

Similar to offer specifications from a merchant, a valid query from a consumer also contains two aspects: body and frame (aka constraints). The boy of a query describes the nature of a need, while the frame of a query describes the situation of the need, such as when and where the need should be fulfilled.

In addition to having consumers to input queries themselves, some/all of the query specifications may also be formed by the remote Consumer Component (FIG. 1, 403) and be transmitted to the service provider automatically, along with the rest of the query (if any) the consumer fills manually. One example of this type of automated query formation is when a user is using the mobile UI on his/her mobile device. In this case, the device location may be captured and transmitted to the referral service of the service provider, without having to ask the consumer to manually input his location.

IV. Referring Consumers to Merchants

The preferred embodiment of the system uses a plurality of methods to refer a consumer to the publishing merchant to make a “referred purchase”. A referred purchase entitles the buying consumer to get the offered price from the merchant and to receive a reward from the service provider. The referral methods range from those fully technically integrated with merchants' business systems to those support manual referrals. Depending on the fee model the selling merchant adopts, the method of referring and proof needed from the buying consumers vary.

1. Under a Member-Qualified Fee Model

Under this model, there is no need to bring proofs of particular offers published by the selling merchant. In fact, as long as a consumer can prove to the merchant that he is a reward program member (such as by showing to merchant or swiping through the merchant's card reader his reward member card), he is entitled to all published offers automatically. All purchases he makes entitle him rewards, regardless what he buys from the merchant. In this scenario, the referral proof is the consumer's reward membership.

2. Under an Offer-Qualified Fee Model

Under this model, in addition to his membership, at the purchase time a consumer must also prove to the merchant that he accepted a particular offer that is to be honored with the published offer price. Otherwise, the purchase is not qualified as a referred purchase and the consumer is not entitled for a reward. The format of offer acceptance proof a merchant accepts varies depending on how this merchant is integrated with the service provider on the referral service or the lack of it.

For example, in case when the merchant's computerized management system is integrated with the service provider, the service provider can transmit the offer acceptance to the merchant electronically once the consumer accepts an offer online. Together the service provider may also transmit the consumer's reward membership to the merchant. At the time of purchasing, the consumer only needs to prove his membership to get the offer price.

Alternatively, a consumer may download and print out an offer then take it with him to the merchant to buy, if the merchant can take the printed copy of his offers and honor them. Or the consumer can simply goes to the merchant, verbally mentions the offer he found from the service provider and buy, when a verbal proof is sufficient for the merchant to horror the offer price.

The service provider may publish the following information to consumers in the referral service regarding the referral methods and proofs needed to make qualified purchases: (1) fee model for each merchant and (2) proof method for qualified referred purchases accepted by each merchant.

V. Consumer Rewarding

The system discloses a cross-merchant consumer reward program sponsored by the service provider. For each qualified purchase transaction, the buying consumer receives a reward in monetary value, which is a portion of the service fee the service provider receives from the selling merchant. The service provider may elect to implement the consumer rewarding program in an open loop model (where all reward proceeds are spent out of the network), an semi open loop model (where reward proceeds are used for future in-network purchases, regardless which network merchant the consumer buys from), or a closed-loop model (where a reward proceed can only be spent toward future purchases from the issuing merchant).

In one open-loop reward program, the service provider creates an account for each registered consumer, and adds monetary value of the reward to the account once a reward is issued to this consumer.

Upon instructions from a registered consumer, the service provider transfers the amount of monetary value from the consumer's reward account to the consumer himself or to a 3^{rd}-party account designated by the consumer. For example, the accumulated reward can be wired to a deposit account of the consumer in a bank at one time or on a regular basis.

In addition to per-transaction rewarding, the system also uses a mechanism to further incrementally reward those registered consumers who have made large numbers of transactions over a period of time. The service provider defines a system of reward levels, each with a different reward percentage that is the percentage of the service fee the service provider passes to buying consumer at that reward level. Higher the level, higher the reward percentage will be.

### TRANSACTION SERVICE PREFERRED EMBODIMENT

I. Validation Reporting Record

To know about an occurred transaction and to minimize possible transaction reporting fraud, the service provider validates each reported transaction before it can be recorded, and subsequently the selling merchant is charged and the buying consumer is rewarded. A transaction reporting record submitted to the Transaction Tracking unit (FIG. 1, 154) must contain validation proofs from both the selling merchant side and the buying consumer side. The validation proofs needed vary depending on the fee model a transaction is based on.

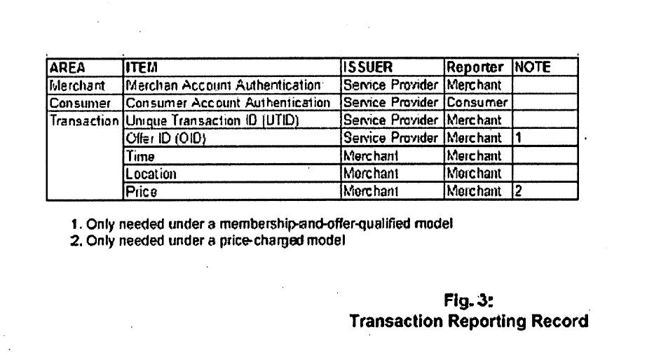

The table in FIG. 3 lists data items generally needed in a transaction record. The record must contain the correct authentication information of the selling merchant affiliation and the correct authentication information of the buying merchant. In the transaction area, at the minimum, it must contain a Unique Transaction ID (UTID) as well as the time when and location where the transaction occurred. If the merchant uses an offer-qualified model, an offer ID (OID) must also be included in the record. When the merchant uses a price-charged model, the transaction reporting record must contain a price figure. The following explains these data items:

1. Merchant Account Authentication

The selling merchant provides the correct authentication information to make the service provider trust the seller of the transaction and associate the transaction to the correct merchant affiliate.

2. Consumer Account Authentication

The buying consumer provides the correct authentication information to make the service provider trust the buyer of the transaction and associate the transaction to the correct registered consumer.

3. Unique Transaction ID (UTID)

The service provider may generate UTID numbers that are unique and non-repeating. UTID may also be provided by the merchant or the 3^{rd-}party transaction tracking provider, provided that they are not conflict with existing and future UTIDs.

4. Offer ID (OID)

The service provider may assign a unique number to each published offer, which is the OID. The OID may be changed for each offer update. The reporting record needs to contain an OID if the selling merchant uses an offer-qualified fee model.

5. Time

This field records the transaction time.

6. Location

This field records the transaction location.

7. Price

This field records the selling price in this transaction. The price figure is only required when the merchant uses a price-charged fee model.

II. Transaction Reporting

This section elaborates on the transaction reporting step (FIG. 2, 2007) in the work flow. The preferred embodiment supports a number of methods to enable each of involved parties in a referred transaction (the merchant, the consumer, or the payment processor) to report a transaction record to the service provider. Supported reporting methods can be categorized into: (1) reporting methods that are integrated with electronic payment settlement and (2) those that are not integrated.

In an integrated scenario, the payment settlement system takes necessary additional information from the buying consumer at the time the purchasing is made. After the payment is settled, the payment settlement processor electronically transmits a record containing necessary information about occurred transaction to the service provider via a provider-trusted communication channel.

In a non-integrated scenario, the consumer collects necessary information, assembles a transaction record, and sends it to the service provider using one means of the consumer user interface (such as Web UI, Mobile UI, or Mail) under a trust-relationship with the service provider (such as requiring consumer log-in). Alternatively, if the selling merchant agrees to submit the transaction record on be half of the buying consumer, the merchant collects, assembles, and transmits the transaction record to the service provider. The merchant can use any means of the provider-trusted merchant UI for reporting transactions. Another way to report that the system supports is to have both the merchant and the consumer co-report via their respective authenticated interface channels with the service provider, with each party may report a partial record. The service provider may then cross checks the validity of the partials and create a complete record if validation is successful.

The following specifies supported scenarios for different reporting parties to report a referred transaction:

1. With Integrated Transaction Reporting

In this scenario, the system of the payment settler (either the merchant himself or a 3^{rd}-party payment processor) settles payment and transmits a transaction record to the service provider electronically. The settler creates a trusted connection with the service provider using the selling merchant's account credentials. Once authenticated, data items in the reporting record are trusted by the service provider.

In such a transaction record, the only data item from the consumer is the consumer's reward membership. As part of the payment process, the buyer needs to give consumer reward account credentials to the payment system. Several ways exist for doing this, including (1) member card swiping and (2) manual input of member ID. The payment system writes consumer member credentials as part of the transaction reporting record to be transmitted to the service provider.

If the merchant adopts an offer-qualified fee model, the payment system needs to add the Offer ID to the transaction record. If the merchant adopts a price-charged fee model, the payment system needs to add the selling price to the transaction record. Both pieces of information will be trusted by the service provider, when received through a trusted channel.

Integrated reporting is the most convenient method to report a transaction. If the record is valid, the selling merchant gets billed for the service and the buying consumer gets rewarded instantly. However, integration reporting require system integration between the settlement system and the service provider's computer systems.

2. Non-Integrated Transaction Reporting—Merchant Reports on Behalf of Consumer

In this scenario, the merchant is responsible for collecting needed information about the transaction and transmit the data to the service provider on behalf of the consumer. The merchant can use any means of the merchant interface to communicate with the service provider. The merchant authenticates and creates a trusted connection with the service provider to report this transaction. As a result, the merchant-side data about this transaction is trusted by the service provider. Similar to the integrated transaction reporting scenario, the only information the merchant needs from the consumer is the merchant's the reward membership.

The merchant either collects all the data electronically using his computerized management system or collects some/all of the data to report manually. Depends on the collection technologies and the transmission technologies used by the merchant, there may be delays of merchant charge and consumer rewarding.

For example, when the selling merchant has a computer in the store that is connected to the internet, he may be able to use service provider's virtual terminal tracking. The “virtual terminal” refers to a web page on the provider's merchant site. After proper authentication, the selling merchant is trusted by the service provider, and can input necessary transaction data items on it then submits the record.

3. Non-Integrated Transaction Reporting—Consumer Reports

In this scenario, the consumer is fully responsible for collecting required transaction-reporting information and submits the record to the service provider. The consumer uses any means of the consumer interface (including Mail) supported to create a trusted access or relationship with the service provider then submit the transaction record. As a result, the service provider trusts reported consumer-side data. To ensure that the consumer is not making up a transaction to report, the consumer may be required to obtain an UTID number from the selling merchant. The consumer also may need to submit a valid price proof when reporting a price.

Depending on the means of the consumer interface used for reporting the transaction, the delay of merchant charging and consumer rewarding can range from very little (when the consumer uses Web or Mobile UI to report once transaction occurred) to much longer (days). The consumer reward incentive is, in fact, one means to encourage consumers to report occurred purchases promptly.

4. Non-Integrated Reporting, Merchant and Consumer Co-Report

In this scenario, the merchant and the consumer agree to co-report a transaction record, where the merchant may collect and report merchant and transaction data fields parts in FIG. 3, whereas the consumer may report consumer data plus a UTID. Each party reports to the service provider its side of the data through respective trusted connection. Therefore, both halves of reports are trusted by the service provider. The service provider combines these half records by the UTID.

The delay for merchant charging and consumer rewarding depends on how quickly both parties submit their parts of the transaction record.

In summary, the transaction reporting feature provided in this invention universally tracks occurred transactions, regardless of the purchasing channel used (such as online purchase or offline retailing), means of payment used (such as cash, check, credit card, debit card, etc), or the payment settlement used (such as merchant self-settlement, 3^{rd}-party settlement). This invention therefore ensures maximum ability for serving merchants by referring consumers to their existing retail establishments.

III. Transaction Validation

Requiring the reporting party to transmit data with proper authentication is the first step for validating a reported transaction. The service provider then uses the data reported regarding a transaction to credit the transaction to correct merchant affiliate and correct registered consumers. Validation also serves a purpose of suppressing transaction reporting fraud.

It is unlikely to have an authenticated merchant to report non-existent transactions since the service provider charges the reporting merchant for each transaction reported and validated. However, an authenticated consumer may report fraudulent or non-existing transactions for getting extra rewards. The following is one feature that the preferred embodiment may use to suppress consumer transaction reporting fraud. When a consumer reports a transaction, the consumer must obtain a unique transaction ID (UTID) number from the merchant. Without a UTID or a non-recognized UTID, a submitted transaction record is invalidated. The given UTID may be checked by the service provider and to link it to a merchant. An UTID may also be linked to a specific point in time or a time range, as to when the transaction with this UTID should have occurred.

In the preferred embodiment of the system, once the Transaction Tracking unit (FIG. 1, 154) of the service provider receives a transaction record over an authenticated connection, it passes the record to the Transaction Validation unit (FIG. 1, 155). The Validation process performs at least the following tests against the transaction record it received. A transaction submission is validated only when all tests below are passed.
1. Merchant Validation. The selling merchant must be an existing merchant affiliate.
2. Consumer Validation. The buying consumer must be an existing registered consumer.
3. Transaction Validation. When reported by a consumer, the UTID must be one that has been assigned to the submitted merchant.

Additional tests for offer-qualified models may include:

The Offer ID (OID) must be the ID of one offer published by the submitted merchant.

The reported transaction time and location must be within the valid offer frame.

Additional tests for price-charged models:

When the record is submitted from a consumer, a valid sales receipt proof must be given and the price on the receipt must match the price reported.

Operation

Set-up

First, the service provider sets up the Service Provider Component (FIG. 1, 101) and publishes the Merchant Component 201 and the Consumer Component 401.

A merchant downloads and installs the tangible Merchant Component on his management system or take notes of the how to communicate with the Service Provider Component using intangible merchant interface. The merchant can use any of the support means to communicate with the service provider. Once the merchant finished installing interfaces to communicate with the service merchant, he uses the preferred merchant interface to execute the merchant registration task. After the successful registration, the merchant becomes a merchant affiliate to the service provider. Then he can use the merchant services provided by the service provider.

If the merchant owns an electronic payment settlement system, he can use integrated transaction tracking after programming the settlement system with the provided transaction API. If the merchant uses a 3^{rd}-party electronic payment settlement system and the system does integrated transaction tracking, the merchant can set up using the integrated tracking by notifying the payment settler his merchant affiliate account credentials.

The service provider works independently with 3^{rd}-party payment processing services for transaction tracking integration.

Prior to publishing any offers, a merchant affiliate needs to determine and notify the service provider his service fee model and the fee schedule.

A consumer downloads and installs tangible Consumer Component 401 to proper computers or devices he will use to communicate with the service provider (Web UI, Mobile UI, etc). The consumer can use any combination of the consumer interface to interact with the service provider. Then the consumer executes the registration task and becomes a registered consumer. One option a registered consumer has is to specify a financial account where the service provider can wire the rewards to. The service provider issues a reward membership card to the consumer once registered.

Use of Service

A merchant affiliate can execute any of the merchant-serving tasks at any time. Mainly, the merchant uses the service to publish and updates its sales offers, report transactions on behalf of requesting consumers if he agrees to do so, monitor performance of his offers, verify the effectiveness of his fee model and fee schedule, and pay service charges to the provider. The service provider provides monthly merchant statements to report and summarize related activities to each merchant.

A consumer mainly uses the system for searching and obtaining offers that match his needs. He then goes to the merchant to purchase goods and services by showing needed referral proof. The consumer then either has the payment processor or the merchant to report this occurred transaction, or he himself does the reporting. He also has access to his reward account. The service provider provides monthly consumer statements to report and summarize related activities to each consumer.

### ALTERNATIVE EMBODIMENTS

Payment Processor

An alternative embodiment is for the system to include its own Payment Processor (FIG. 1, 504), which will be tightly integrated with the Transaction Tracking unit 154. In this way, the service provider offers merchant affiliates a default payment settlement option that always tracks referred transactions instantly. Another implication is that with an owned payment processor, the service provider can turn consumer reward accounts into credit or debit accounts in the way that the rewarded values can be used directly for future purchases via the owned payment processor. This also implies that issued reward cards can be used as credit or debit cards in retail transactions.

Consumer Referral

In an alternative embodiment, the service provider can add additional service features to the consumer referral service. For example, the shipping service can be implemented as one way of consumer referral. In stead of having to have a referred consumer to go to merchant to purchase, once the consumer accepts an offer, the product or services can be shipped to the consumer directly.

Another alternative works for consumers who do not want to or do not have time to do product browsing in a brick-and-mortar store. For these consumers, the referral service can instruct the merchant to prepare the products for the consumer before he arrives at the store. The consumer can quickly pick up the products prior-selected through the referral service, pay, and go.

In yet another alternative embodiment, a reversed referral can be implemented. Rather than referring consumers to merchants, merchants can be referred to consumers as well. In a reversed referral scenario, consumer publishes needs via the service provider. Merchants search for needs that they can serve, and publish offers tailored to these needs.

Merchant Offer Aggregation and Distribution to Consumer Destinations

The system may also support scenarios where the service provider may collect offers from merchants and may deliver them to consumers via a plurality of online consumer destinations or third party content publishers, including but not limited to search engines (i.e. Google, Yahoo), content web sites, online directory sites, online community sites. In addition, the service provider may also deliver collected merchant offers to other third party consumer destinations through various delivery channels such as Short Message Service (SMS), delivering them for viewing on mobile devices, and interactive cable TV, etc. All of these consumer destinations may use a plurality of different fee models for delivering merchant offers to consumers, including pay-per-click (CPC) and pay for listing fee models.

In essence, the service provider may become a merchant offer aggregator and broker, who delivers collected offers to affiliated consumer destinations; and these affiliated destinations in turn deliver received offers to individual consumers. When offer deliveries from affiliated destinations to consumers result in purchases at POS in store, the service provider may need to disburse a portion of received transaction fees to contributing consumer destinations.

The system thus provides a method (using an proceeds distribution module that is part of the transaction front end 152 in the exemplary embodiment) for distributing proceeds received from transaction fees from merchants to affiliated consumer destinations that contributed in driving consumers to the merchant stores to make purchases. The process may include an offer collection process (described above), an offer distribution process, an offer delivery process, a purchase transaction process, a commission charge process, a delivery to purchase casual relationship determination process and a proceeds distribution process. During offer collection process, the service provider collects offers from participating merchants. During the offer distribution process, the service provider delivers the collected offers to a plurality of affiliated consumer destinations. During the offer delivery process, at least one affiliated consumer destination presents a particular received offer to one or more consumers. During the purchase transaction process (described above), the consumer(s), who are influenced by the offer presented, go to the physical location (i.e. store) of the publishing merchant and make a purchase which is captured on the service membership card. During the commission charge process (described above), the service provider charges the selling merchant a commission fee based on pre-determined rate, such as a percentage of the purchase price or as a fixed monetary value as described above. During the delivery to purchase casual relationship determination, the service provider and the affiliated consumer destination determine the causal relationship from user actions from consumer destinations (such as clicks on Search keyword ads or impressions on display ads) to resulted purchase transactions. Usage and transaction integration may be necessary in this step. During the proceeds distribution process, the service provider distributes a portion of the received proceeds from selling merchant to each of the affiliated consumer destinations for service during the offer delivery process, based on the causal relationship determined in the delivery to purchase casual relationship determination process. In the above method, the offer delivery process is another extension from the previously described offer delivery process since there may be a plurality of affiliated consumer destinations, in addition to the service provider's own consumer destination (if there may be one).

In some embodiments of the delivery to purchase casual relationship determination and proceed distribution processes, the causal relationship from user actions on consumer destinations to resulted purchase are determined statistically using data from both sides in aggregation. For example, a portion of the commission fee (called the disbursable portion of the fee) may be disbursed to contributing consumer destinations. The conversion denominator may be determined by the aggregated total number of user actions on published merchandising information across all participating consumer destinations. The service provider may distribute a portion of the convertible fee to each participating consumer destination, proportionally to the number of online user actions occurred on this destination, relative to the total user actions aggregated across all affiliated consumer destinations. For instance, if there are 100 clicks that lead to one purchase from all participating consumer destinations, then each click gets 1% (I transaction divided by 100 clicks) of the disbursable portion of the transaction fee. Assuming one consumer destination A contributed 60 clicks and another destination B contributed 40 clicks, destination A and destination B each, respectively, gets 60% and 40% of the disbursable proceeds from the service provider. Obviously, other and possibly more complex statistical algorithms and modeling may be used to determine the proceeds disbursement distribution of the transaction fee across affiliated consumer destinations.

In other embodiments of the delivery to purchase casual relationship determination and proceed distribution processes, online users who performed online actions leading to resulted in-store purchases may be identified and linked to physical consumers who bought the product or service in the resulted transactions. In other words, the causal relationship may be determined at individual consumer level. Such online user to offline buyer identification and linkage may be done explicitly, by identifying users in a common identification system that applies to both online actions and in-store purchases, or create a linkage between an offline consumer identification system and one or more online user identification system(s).

One explicit identification option is that a consumer destination may require users to log in using the service provider's consumer membership. The online user/in-store buyer linkage may also be created implicitly and/or algorithmically for anonymous online users. One may look at other parameters (other than, and/or in addition to user identification) of online user actions and in-store purchases to link a destination user to in-store purchases. Useable parameters may include time and location relationship between online consumer destination actions and in-store purchases.

Another explicit identification option is that a consumer destination may install a specialized “click-recording” software detection and conversion product, either as an extension to their currently used method of consumer tracking, or as a new service that may either be provided by the service provider or developed by the consumer destination provider (subject to the design requirements of the service provider). This extension software will produce a unique identifier code for each click action by a consumer on the offer displayed by the consumer destination. This extension code (which may maintain anonymity of the consumer), is then transferred back to the service provider's database, where it is reconciled with the subsequent sale transaction by the specific consumer whose online “click” action generated the extension code. The online consumer destination will then be apportioned a percentage of the commission fee collected by the service provider.

While the foregoing has been with reference to a particular embodiment of the invention, it will be appreciated by those skilled in the art that changes in this embodiment may be made without departing from the principles and spirit of the invention, the scope of which is defined by the appended claims.

1. A computer implemented system for tracking sales transactions, in particular for offline sales transactions, comprising:
a service provider component implemented on a computing device wherein the service provider component further comprises a merchant unit, a transaction unit and a consumer unit wherein the merchant, transaction and consumer units each further comprise a plurality of lines of computer code executed by a processing unit of the computing device that executed the merchant, transaction and consumer units, the merchant, transaction and consumer units implementing a method for tracking sales transactions, in particular for offline transactions, comprising:
providing, by an online adverting system associated with the service provider component, a sales offer from a particular merchant to a consumer;
tracking a plurality of sales transactions, in particular offline sales transactions, that are submitted to the service provider component;
validating, at the service provider component, each sales transaction to determine if the sales transaction is a validated referral sales transaction for the particular merchant; and
charging, by the service provider component, a commission fee for the validated referral sales transaction to the particular merchant.

2. The system of claim 1, wherein the method for tracking sales transactions, in particular offline sales transactions, further comprising providing, by the service provider component, a reward to the consumer for the referral sales transaction.

3. The system of claim 1, wherein tracking the plurality of sales transactions, in particular offline sales transactions, in the method for tracking sales transactions further comprises capturing sales transactions near the point of sale of the sales transaction and storing the sales transactions in a central database associated with the transaction settled consumer referral and reward system.

4. The system of claim 3, wherein capturing the sales transactions, in particular offline sales transactions, in the method for tracking sales transactions further comprises using a card or a membership proof at the point of sale to capture each sales transaction wherein the card further comprises a magnetic strip card or a credit card.

5. The system of claim 1 further comprising an online advertising system associated with the service provider component, the online advertising system further comprising a mobile device or a interactive cable television system.

6. The system of claim 1 further comprising a merchant component, at each merchant location, that permits a merchant to interface with the merchant unit of the service provider component.

7. The system of claim 1 further comprising a consumer component, at each consumer location, that permits a consumer to interface with the merchant unit of the service provider component.

8. The system of claim 1, wherein the merchant unit further comprises a trusted merchant rating stored in the merchant unit that rates each merchant.

9. The system of claim 1, wherein providing a sales offer further comprises providing a brokered advertisement to the user.

10. The system of claim 1, wherein the merchant unit further comprises a commission bidding unit wherein the merchants bid for a higher commission and the higher commission sales offer is more prominently displayed to the user.

11. A method for tracking sales transaction, in particular offline transactions, the method comprising:
providing, by an online adverting system associated with a transaction settled consumer referral and reward system, a sales offer from a particular merchant to a consumer;
tracking a plurality of sales transactions, in particular offline transactions, that are submitted to the transaction settled consumer referral and reward system;
validating, at the transaction settled consumer referral and reward system, each sales transaction to determine if the sales transaction is a referral sales transaction for the particular merchant; and
charging, by the transaction settled consumer referral and reward system, a commission fee for the referral sales transaction to the particular merchant.

12. The method of claim 11 further comprising providing, by the transaction settled consumer referral and reward system, a reward to the consumer for the referral sales transaction.

13. The method of claim 11, wherein tracking the plurality of sales transactions, in particular offline transactions, further comprises capturing sales transactions near the point of sale of the sales transaction and storing the sales transactions in a central database associated with the transaction settled consumer referral and reward system.

14. The method of claim 13, wherein capturing the sales transactions, in particular offline transitions, further comprises using a card or membership proof at the point of sale to capture each sales transaction wherein the card further comprises a magnetic strip card or a credit card.

15. The method of claim 11, wherein the online advertising system further comprises a mobile device or an interactive cable television system.

16. The system of claim 11 further comprising establishing a trusted merchant rating stored in the merchant unit that rates each merchant.

17. The system of claim 11, wherein providing a sales offer further comprises providing a brokered advertisement to the user.

18. The system of claim 11 further comprising establishing a commission bidding system wherein the merchants bid for a higher commission and the higher commission sales offer is more prominently displayed to the user.

19. A computer implemented system for merchant advertising, comprising:
a service provider component implemented on a computing device wherein the service provider component further comprises a merchant unit, a transaction unit and a consumer unit wherein the merchant, transaction and consumer units each further comprise a plurality of lines of computer code executed by a processing unit of the computing device that executed the merchant, transaction and consumer units, the merchant, transaction and consumer units implementing a method for merchant advertising comprising:
providing a merchant interface to each merchant of the merchant advertising system, the merchant interface providing real-time control of the publication, update and modification of the online advertisements for a particular merchant, each online advertisement having a geographic area associated with the online advertisement and a commission to be paid a service provider upon resulted sales from the online advertisement;
electronically displaying, on a map, the online advertisements in a particular geographic area for all merchant based on the geographic area associated with each online advertisement; and
bidding, using a commission bidding system, for a commission associated with each online advertisement wherein the commission payment paid to the service provider and a loyalty reward to a consumer for a particular online advertisement is attenuated based on the bidding.

20. The system of claim 19, wherein the method for merchant advertising further comprises selecting, based on the commissions for each online advertisement in a geographic area, the online advertisements shown to a consumer in the geographic area.

21. The system of claim 20, wherein selecting the online advertisements further comprising selecting a particular online advertisement based on a highest commission associated with the particular online advertisement.

22. The system of 19, wherein displaying the online advertisements in a particular geographic area further comprises displaying the map on a web browser.

23. The system of claim 19, wherein displaying the online advertisements in a particular geographic area further comprises using a global positioning system (GPS) navigation system to display the map.

24. The system of claim 19, wherein the online advertisements further comprises an advertisement generated based on a local shopping specific search.

25. The system of claim 19, wherein the online advertisements further comprises real-time offers rendered on the map.

26. A method for merchant advertising, the method comprising:
providing a merchant interface to each merchant of the merchant advertising system, the merchant interface providing real-time control of the publication, update and modification of the online advertisements for a particular merchant, each online advertisement having a geographic area associated with the online advertisement and a commission to be paid a service provider upon utilization of the online advertisement;
electronically displaying, on a map, the online advertisements in a particular geographic area for all merchant based on the geographic area associated with each online advertisement; and
bidding, using a commission bidding system, for a commission associated with each online advertisement wherein the commission payment paid to the service provider and a loyalty reward to a consumer for a particular online advertisement is attenuated based on the bidding.

27. The method of claim 26 further comprising selecting, based on the commissions for each online advertisement in a geographic area, the online advertisements shown to a consumer in the geographic area.

28. The method of claim 27, wherein selecting the online advertisements further comprising selecting a particular online advertisement based on a highest commission associated with the particular online advertisement.

29. The method of 26, wherein displaying the online advertisements in a particular geographic area further comprises displaying the map on a web browser.

30. The method of claim 26, wherein displaying the online advertisements in a particular geographic area further comprises using a global positioning system (GPS) navigation system to display the map.

31. The method of claim 26 further comprising generating an online advertisement, the online advertisements being generated based on a local shopping specific search.

32. The method of claim 26 further comprising rendering, in real time, the advertisements to be displayed on the map.

33. A method for distributing proceeds received from transaction fees from one or more merchants to one or more affiliated consumer destinations that contributed in driving consumers to one or more merchant stores to make purchases, the method comprising:
collecting one or more offers from one or more merchants;
distributing the one or more offers to a plurality of affiliated consumer destinations;
delivering, by at least one affiliated consumer destination, the one or more offers to one or more consumers;
capturing a purchase, based on the delivered offer, by a consumer of a product from a selling merchant; and
distributing a commission from the captured purchase between the selling merchant and the at least one affiliated consumer destination.

34. The method of claim 33, wherein distributing the commission further comprises determining a causal relationship between the purchase and a user action associated with the at least one affiliated consumer destination and distributing the commission based on the determined causal relationship between the purchase and the at least one affiliated consumer destination.

35. The method of claim 33 further comprising charging a commission fee to the selling merchant for the captured purchase.

36. The method of claim 35, wherein charging the commission fee further comprises charging the commission based on a percentage of a price of the purchase or a fixed monetary value.
